(19) United States
(12) Patent Application Publication
(10) Pub. No.: US 2008/0015985 A1
(43) Pub. Date: Jan. 17, 2008

(54) SYSTEM AND PROCESS FOR EXPEDITED PAYMENT THROUGH ONLINE BANKING/PAYMENT CHANNEL

(76) Inventors: Armand Abhari, Danville, CA (US); Brian M. Pearce, Pleasanton, CA (US); Karen L. Shahoian, Oakland, CA (US); Catherine Crowell, Alameda, CA (US)

Correspondence Address: GLENN PATENT GROUP, 3475 EDISON WAY, SUITE L, MENLO PARK, CA, 94025, US

(21) Appl. No.: 11/776,315

(22) Filed: Jul. 11, 2007

Related U.S. Application Data
(60) Provisional application No. 60/807,040, filed on Jul. 11, 2006.

(51) Int. Cl. G06Q 40/00

(52) U.S. Cl. 705/42

(57) ABSTRACT

A system and associated process for expedited payment between a first computer (e.g. a customer computer or a bank computer) and a biller computer, e.g. within the US, is implemented over an online banking or payment network. A payment request for an expedited, e.g. same day, payment is received at the central system from the first computer, wherein the request includes identification of an intended payee, e.g. biller, and identification of a funding account associated with the customer. The system verifies if the funding account has sufficient funds available for the requested transaction, which preferably includes an associated fee. The system then sends a message to a vendor service, e.g. external, if the funding account has sufficient funds available for the requested transaction. The vendor service sends payment information to the biller computer, and sends a payment message back to the payment system, which debits the funding account for the transaction, if successful. The banking/payment system preferably provides other payment methods, wherein a customer can selectably choose between payment methods.

### CROSS REFERENCE TO RELATED APPLICATIONS

This Application claims priority to U.S. Provisional Application No. 60/807,040, entitled Allow Bill Pay Customers to Effect Same Day Payment to Eligible Billers within the US Via Online Banking/Bill Pay Channel, filed 11 Jul. 2006, which is incorporated herein in its entirety by this reference thereto.

### FIELD OF THE INVENTION

The invention relates to online banking and payment systems between devices operating across a network. More particularly, the invention relates to systems, processes and associated structures that provide expedited payments from client users to eligible recipients between devices operating across a network.

### BACKGROUND OF THE INVENTION

Many customers currently have either a need or a desire to have funds delivered more quickly than traditional options now available, and are often willing to pay an additional fee for such an expedited service.

Currently, online banking customers, such as through Bill Pay, available through Wells Fargo Bank Inc., of San Francisco, Calif., must schedule bill payments at least five full business days prior to the payment due date at the payee for check payments, and up to three full business days for electronic payments.

It would therefore be advantageous to provide a system and associated process for expedited payments. The development of such a payment system and process would constitute a major technological advance.

It would also be advantageous to provide a system, structure and method such that funds may be delivered more quickly for customer users than traditional options currently available. The development of such an expedited payment system would constitute a major technological advance.

Additionally, it would be advantageous to provide a system and process that provides customers with the ability to make a “last minute” or same day payment, such as for a mortgage, credit card or utility payment, for an additional fee. The development of such a payment system and process would constitute a further technological advance.

Furthermore, it would also be advantageous to provide a system and process that provides customers with the ability to make an expedited payment, such as to avoid any of late charges, penalties, disconnections and negative remarks on credit reports. The development of such a payment system and process would constitute an additional technological advance.

As well, it would also be advantageous to provide an expedited payment system and process wherein customers would receive peace of mind by obtaining a confirmation that an expedited payment had been received, and not have to worry about their credit obligation. The development of such a payment system and process would constitute a substantial technological advance.

In addition, it would be advantageous to provide an expedited payment system and process that provides sufficient value of the customer to justify paying a fee associated with one or more expedited payments. The development of such a payment system and process would constitute a valuable technological advance.

As well, it would be advantageous to provide a payment system that provides structures and methodologies for services for which customer users are willing to pay additional fees, such as a transaction fee for one or more expedited payments. The development of such a payment system would constitute a major technological advance.

### SUMMARY OF THE INVENTION

A system and associated process for expedited payment between a first computer (e.g. a customer computer or a bank computer) and a biller computer, e.g. within the US, is implemented over an online banking or payment network. A payment request for an expedited, e.g. same day, payment is received at the central system from the first, computer, wherein the request includes identification of an intended payee, e.g. biller, and identification of a funding account associated with the customer. The system verifies if the funding account has sufficient funds available for the requested transaction, which preferably includes an associated fee. The system then sends a message to a vendor service, e.g. an external vendor, if the funding account has sufficient funds available for the requested transaction. The vendor service sends payment information to the biller computer, and sends a payment message back to the payment system, which debits the funding account for the transaction, if successful. The banking/payment system preferably provides other payment methods, wherein a customer can selectably choose between payment methods.

### BRIEF DESCRIPTION OF THE DRAWINGS

FIG. 1 is a schematic view of a high-level payment process for a same day payment system;

FIG. 2 is an exemplary schematic diagram of a same day payment system implemented across a network;

FIG. 3 is a schematic block diagram of a Customer User Interface (CUI) for a same day payment system implemented within an online banking system network;

FIG. 4 is a schematic block diagram of a customer service application (CSA) for a same day payment system implemented within an online banking system network;

FIG. 5 is a schematic block diagram of an online administration tool (OAT) for a same day payment system implemented within an online banking system network;

FIG. 6 is a schematic block diagram of same day payment system actors for a same day payment system implemented within an online banking system network;

FIG. 7 is a schematic block diagram of an exemplary batch/database module for a same day payment system implemented within an online banking system network;

FIG. 8 is a schematic block diagram of interactions associated with a customer user interface (CUI) for same day payment within an online banking system;

FIG. 9 is a schematic block diagram of interactions associated with a customer service application (CSA) for same day payment within an online banking system;

FIG. 10 is a schematic block diagram of payee management operations associated with an online administration tool (OAT) for same day payment within an online banking system;

FIG. 11 is a schematic block diagram of interactions associated with a same day payment system batch/database for an exemplary online banking system;

FIG. 12 is a system architecture component diagram for an exemplary same day payment system implemented within an online banking system network;

FIG. 13 is an interaction model communication diagram for an exemplary same day payment system implemented within an online banking system network;

FIG. 14 is a functional schematic diagram of an exemplary load balancing structure for a same day payment system implemented within an online banking system network;

FIG. 15 is a process flow diagram for an exemplary expedited, e.g. same day, payment process implemented within an online banking system;

FIG. 16 is a screenshot of an exemplary online payment, e.g. Bill Pay, overview screen for a same day payment system implemented within an online banking system network;

FIG. 17 is a screenshot of an exemplary make payment screen for a same day payment system implemented within an online banking system network;

FIG. 18 is a screenshot of an exemplary payment verification screen for a same day payment system implemented within an online banking system network;

FIG. 19 is a screenshot of an exemplary payment confirmation screen for a same day payment system implemented within an online banking system network;

FIG. 20 is an exemplary schematic interaction diagram for the transmission of payment instructions for a same day payment system implemented within an online banking system network;

FIG. 21 is an exemplary schematic diagram of reverse payment interactions for a same day payment system implemented within an online banking system network;

FIG. 22 is an exemplary schematic diagram for the establishment, updating, and/or retrieval of a list of eligible billers for a same day payment system implemented within an online banking system network;

FIG. 23 is an exemplary schematic diagram of daily settlement interactions for a same day payment system implemented within an online banking system network; and

FIG. 24 is a schematic component and interconnection diagram between system entities for an exemplary same day payment system implemented within an online banking system network.

### DETAILED DESCRIPTION OF PREFERRED EMBODIMENTS

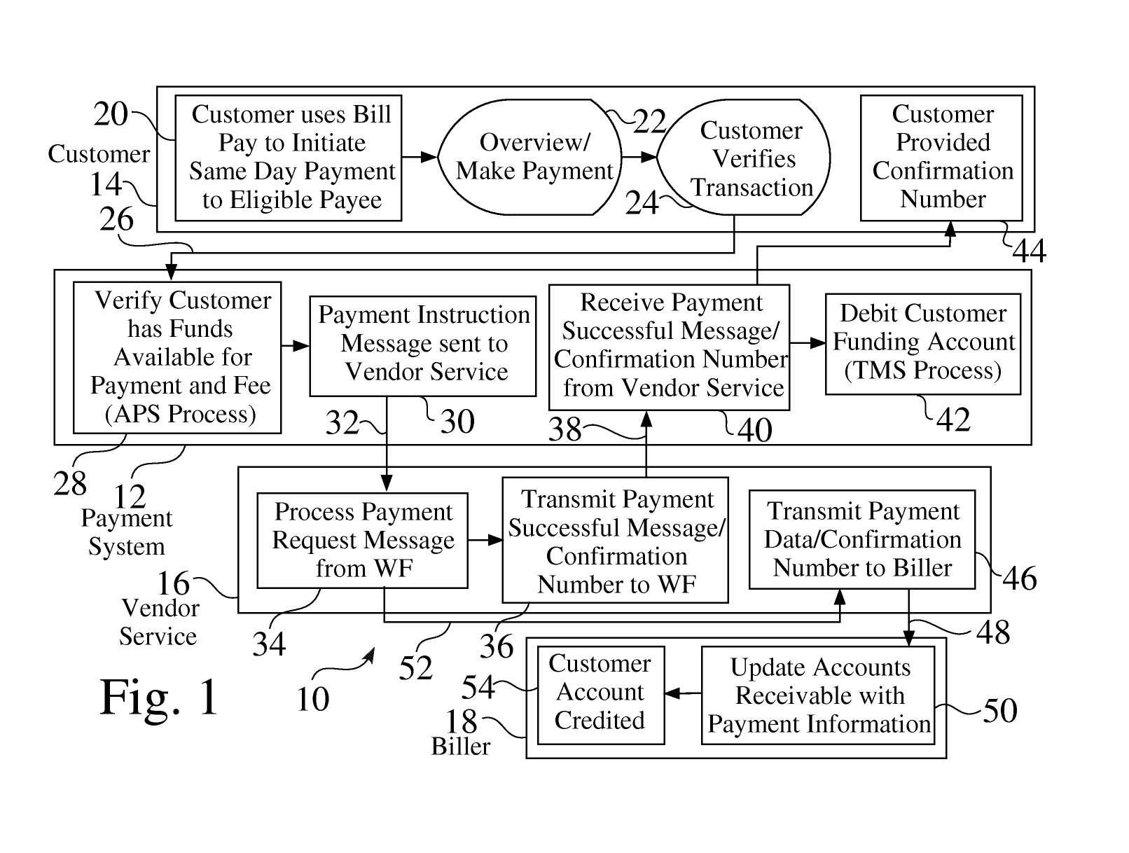

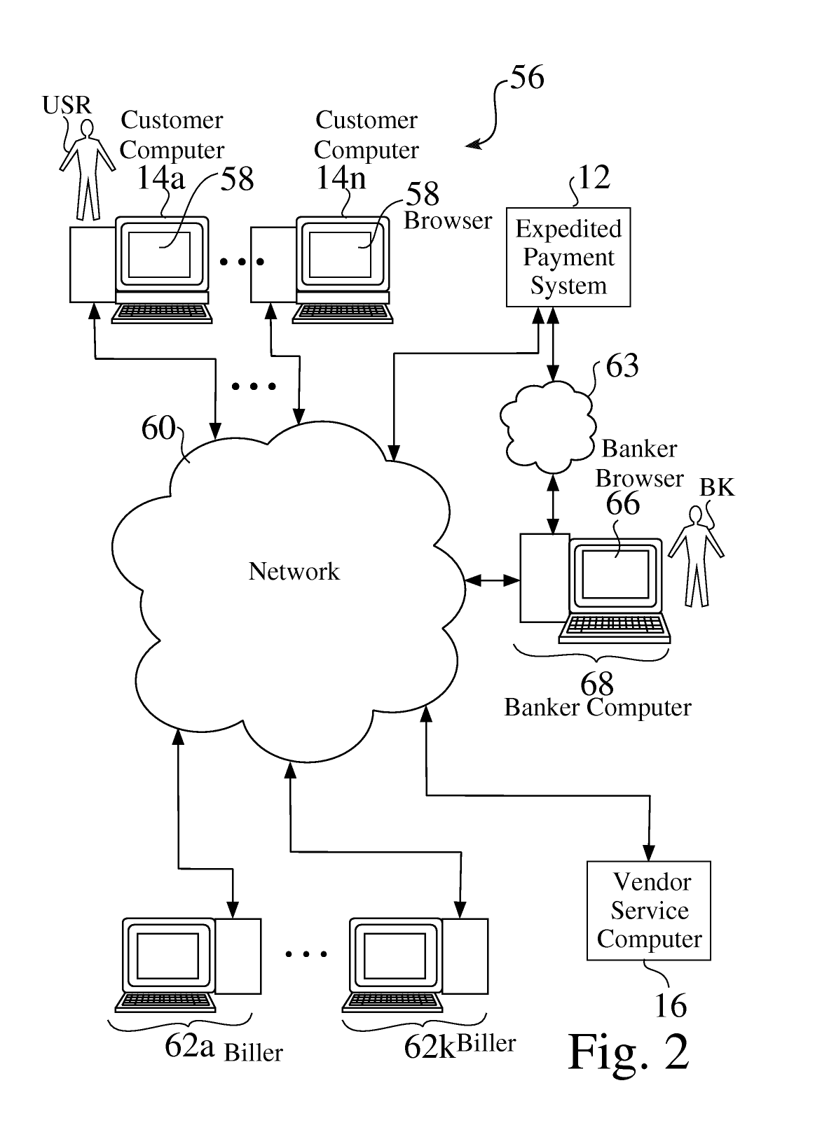

FIG. 1 is a schematic view of a high-level payment process for an expedited, e.g. same day, payment system 10 implemented across a network. FIG. 2 is an exemplary schematic diagram of a same day payment system 10 implemented across a network.

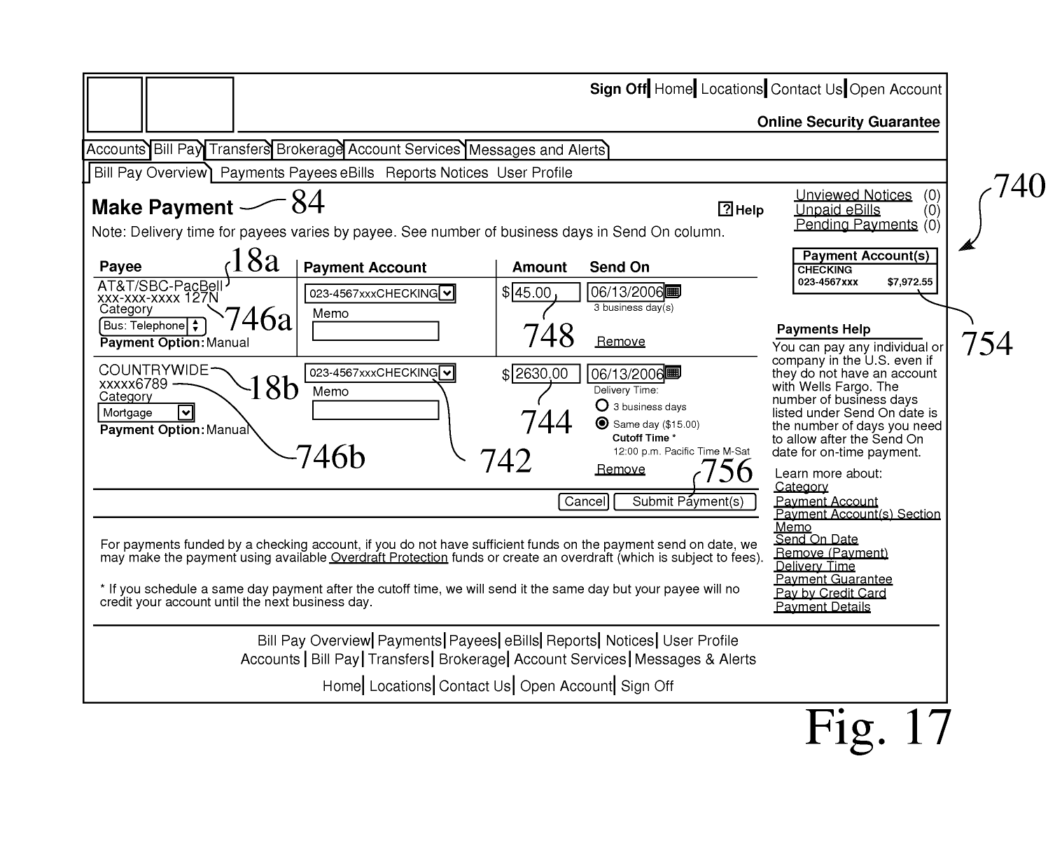

As seen in FIG. 1, a customer user USR (FIG. 2) at a user terminal, i.e. computer 12, interacts with an online banking payment system 12, e.g. such as Bill Pay, available through Wells Fargo Bank, Inc., of San Francisco, Calif. The online payment system 12 manages expedited payments from an account 742 (FIG. 17) associated with the customer USR to a biller at a biller terminal 18, through an intermediate vendor service system 16, such as provided by Western Union Financial Services, Inc., of Greenwood Village, Colo.

While the exemplary expedited payment system 12 seen in FIG. 1 and FIG. 2 shows a single vendor service 16 that may be external and/or independent from the payment system 12 or associated financial institution, e.g. Wells Fargo Bank, the expedited payment system 12 is not limited to a single external vendor service 16. For example, more than one vendor service 16 may preferably used. As well, in some embodiments of the expedited payment system 12, the vendor service 16 may be an internal system module 16, or may otherwise be associated with the payment system 12 or associated financial institution, e.g. Wells Fargo Bank.

In the exemplary process seen in FIG. 1, a customer USR, through a user terminal 12, uses the online banking system 12 to initiate 20 a same day payment 744 (FIG. 17) to an eligible payee, i.e. biller 18. The user USR overviews and makes 22 a payment, and preferably verifies 24 the transaction, which is sent 26 to the online payment system 12.

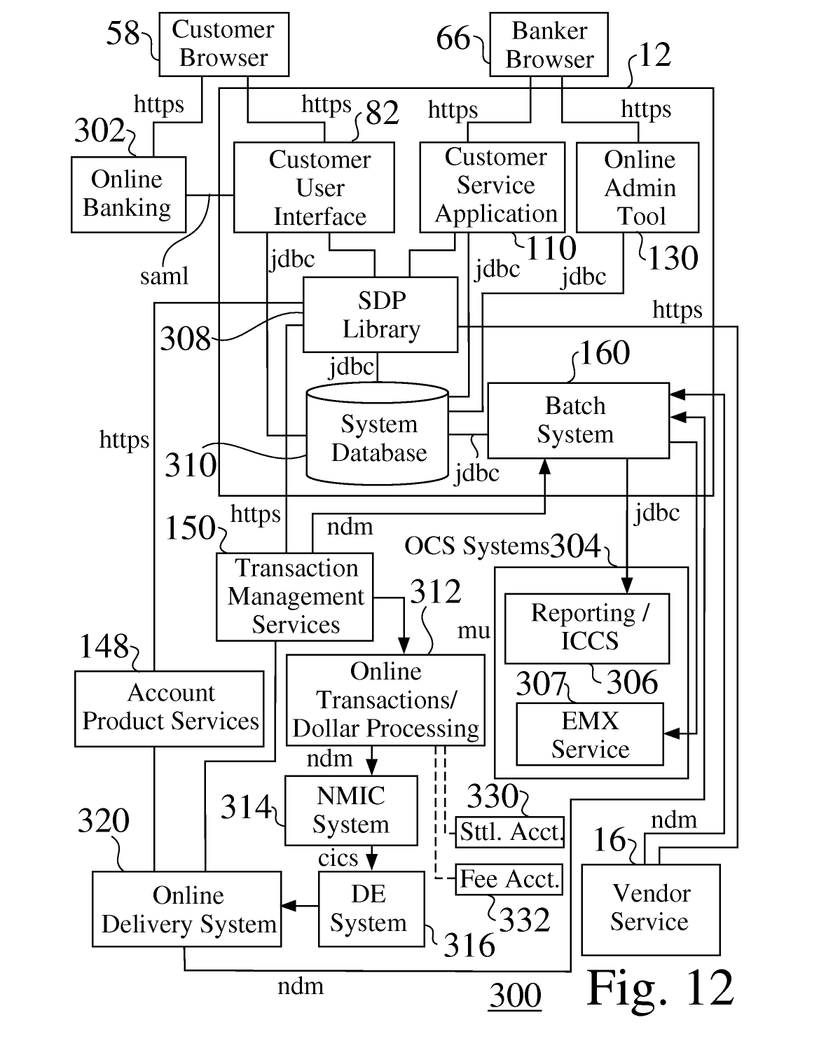

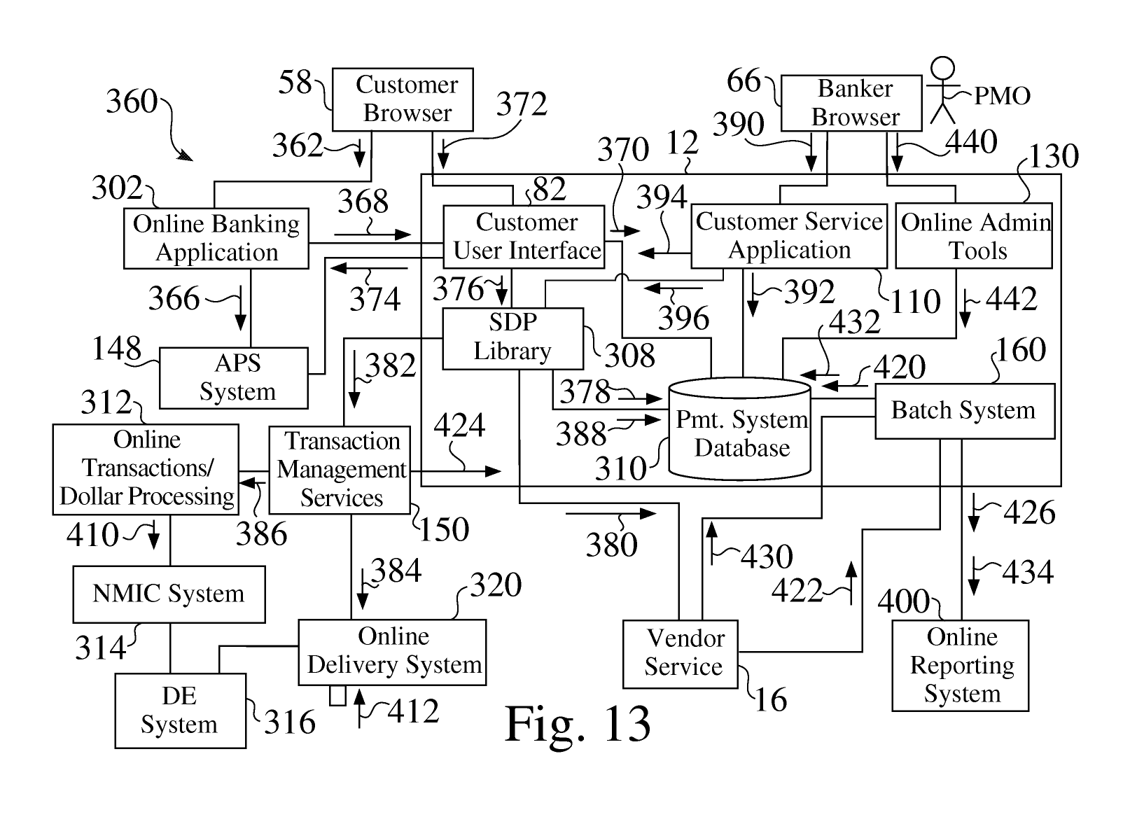

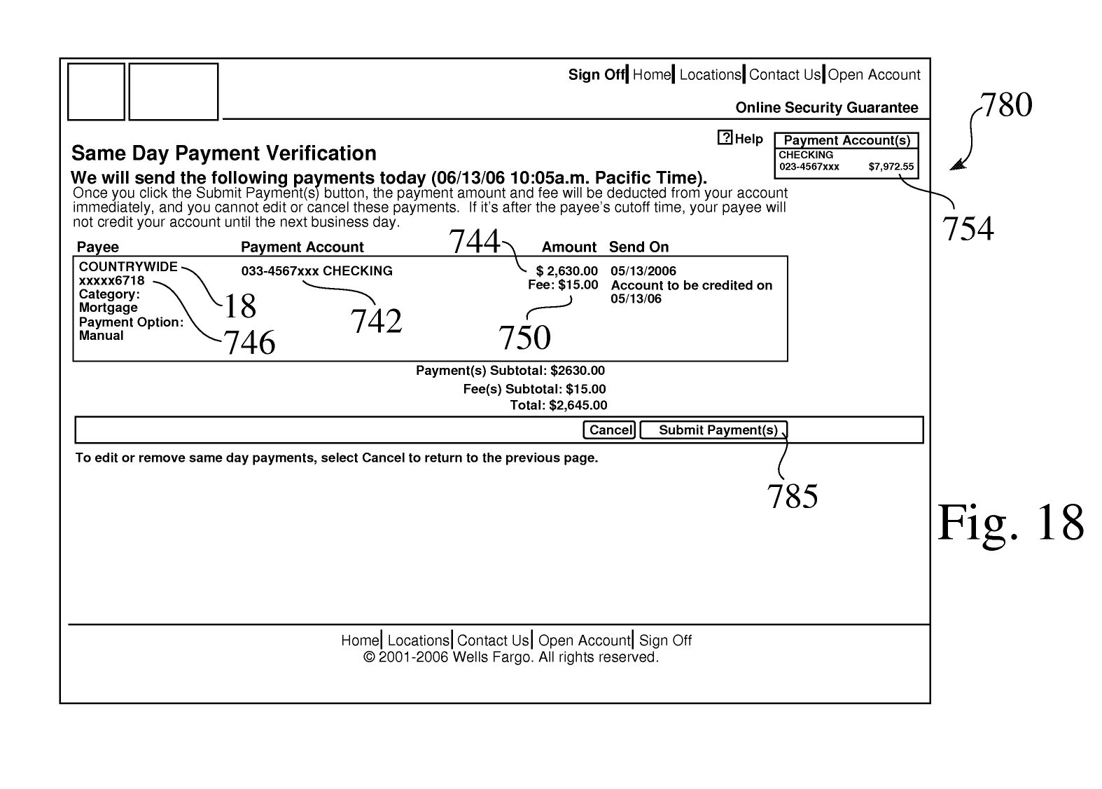

The online payment system 12 verifies 28 that the customer has funds 754 (FIG. 17) available for the payment 744, and also preferably for a fee 750 (FIG. 18) that may be associated with the expedited payment 744, such through an account product services (APS) process or system 148 (FIG. 12, FIG. 13). Upon verification 28 of funds 754, the online payment system 12 prepares 30 an instruction message, which is sent 32 to the vendor service 16.

The vendor service 16 processes 34 the payment request message received 32 from the online payment system 12, and then prepares 46 and transmits 48 payment data, such as including a confirmation number to the payee, i.e. biller 18. The vendor service 16 also prepares 36 and transmits 38 a payment successful message/confirmation number to the online payment system 12.

The online payment system 12 receives the sent 38 payment successful message/confirmation number, debits 42 the customer funding account 742 (FIG. 17), such as through transaction management services 150 (FIG. 12, FIG. 13), and sends a payment confirmation number 44 to the customer terminal 14.

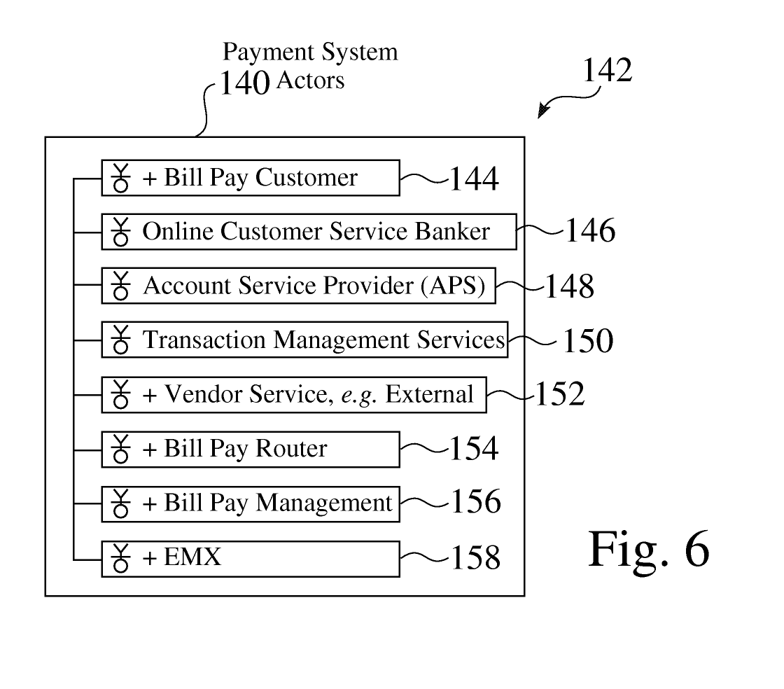

The transaction management services module 150 (FIG. 6, FIG. 12) typically debits funds in real time from the funding account 742, e.g. a demand deposit (DDA) account 742, associated with and selected by the customer user USR. The fund debit typically comprises two separate memo postings, for the transaction amount 744, and for the transaction fee 750, if applicable, to reserve or freeze the associated transaction funds from the funding account 742.

The transaction management services module 150 typically follows up with batch hard posting of transactions at end of the day, to confirm the real time memo post to the customer's funding account 742 e.g. demand deposit (DDA) account 742. The transaction management services module 150 also sends batch hard post credit transactions at the end of the day to the online transactions/dollar processing system component 312 (FIG. 12, FIG. 13).

The transaction management services module 150 overdrafts customer's funding account 742 if necessary. The transaction management services module 150 also confirms that transactions do not fail, and, in current embodiments, ensures that a customer USR is charged only one overdraft fee for the two transactions 744,750 associated with an overdraft.

As seen in FIG. 1, upon receipt 48 of the payment data/confirmation number at the biller terminal 18 from the vendor service 16, the payee/biller 18 typically updates 50 the accounts receivable with the payment information, and credits 54 the customer's credit/debt account 746, e.g. 746b (FIG. 17).

Customers USR often have a need/or desire to have funds delivered more quickly than traditional options and are willing to pay an additional fee for an expedited payment. The Same Day Payments (SDP) system 10 allows customers to make a last minute or same day payment, such as for but not limited to a mortgage, a credit card or a utility payment.

Use of the same day payment system 10 typically includes an additional fee 750 that is charged to the customer USR, such as through the same funding account 742 that is used for the intended payment. In some embodiments of the expedited payment system 10, expedited payments are not limited to fee 750 per transaction 744, such as for a product or service offering through the payment system 12 or associated financial institution, e.g. Well Fargo. For example, some customers USR at a designated service level may be allowed to send up to a designated number of expedited payments during a given period, e.g. up to five same day transactions per month. As well, some customers USR may be charged an expedited fee for a plurality of transactions, e.g. $20 US for up to five transactions in a three-month period.

Through the use of the same day payment system 10, a customer USR can avoid any of late charges, penalties, disconnections and/or negative marks on credit reports. As well, a customer USR receives peace of mind, by obtaining a confirmation that their expedited payment has been received, so they don't have to worry about their credit obligation to the biller 16. The user USR therefore receives great value through the expedited payment system 10,12, which can easily justify associated transaction fees 750, through which the provider of the online payment system 12 is automatically compensated.

The same day payment system 10 and associated processes comply with all current regulations, e.g. Regulation E and OFAC regulations. Customers USR are typically required to evoke expedited transactions within an authenticated online session. Vendor services 16 are typically required to meet all information security guidelines required by the online payment system 12 and associated financial institution. As well, all transmissions between the online payment system 12 and external vendor services 16 are sent securely.

Some embodiments of the same day payment system 10 and associated processes allow customers USR to effect a same day payment to eligible billers 18 domestically, for an additional fee. For example, for a same day payment system 12 and associated financial institution located in the United States, the same day payment system 10 and associated processes allow customers USR to effect a same day payment to eligible billers 18 that are also located within the United States, for an additional fee 750.

Messaging, such as comprising requests, acknowledgements and responses, between the online payment system 12 and external service providers 16, such as between a Bill Pay server 12 associated with Wells Fargo and a vendor service terminal 16 associated with Western Union, is preferably provided in real-time, to make payments 744 to an eligible biller 18 within the United States for a vendor service 16 that provides same day payment processing.

For example, the external vendor service 16 shown in FIG. 1 and FIG. 2 accepts a real time request from the payment system 12, such as through the bank entity, e.g. Wells Fargo, to process a same day payment 744. The vendor service 16 validates the transaction, including verification of the account number 742 and/or account mask, and returns either a positive or negative acknowledgement.

The vendor service 16 typically guarantees payment to the biller 18 when the acknowledgement 36 of the same day payment 744 is returned to the expedited payment system 12, and typically provides payment detail for periodic, e.g. daily, settlement and reconciliation.

The vendor service 16 preferably transfers on a periodic basis, e.g. daily, weekly, bi-weekly, or monthly, a list of eligible billers 18, which preferably includes at least the following data items:
biller's name
biller's location;
biller type;
biller availability; and
biller's last cut-off time.

The vendor service 16 may also provide a wide variety of other features, such as but not limited to providing customer service for the same day payment system 12, e.g. such as through an online customer service (OCS) module 304 (FIG. 12). For example, the vendor service 16 typically provides the OCS module 304 with means to track same day payments 744. The vendor service 16 also typically adheres to all security protocols of the same day payment system 12 and the bank entity, e.g. Wells Fargo.

As seen in FIG. 2, a customer user USR typically connects to the same day banking system 12 through a browser application 58 at a customer computer 14, e.g. 14a-14n, which may preferably be connected to the same day banking system 12 through a network 60, e.g. the Internet.

Similarly, a banker user BK typically connects to the same day banking system 12 through a banker browser application 66 at a bank computer 68, which may be connected to the same day banking system 12 through a network 60, e.g. the Internet, or through an alternate network 63.

As well, a biller 18 may typically connect to the banking network 10, such as to a vendor service 16 or to the payment system 12, through a biller computer 62, e.g. 62a-62k, which may be connected through a network 60, e.g. the Internet.

Enhanced Interfaces and Applications Associated with the Expedited Payment System. The expedited, i.e. same day, payment system 12 comprises a variety of enhanced structures and interfaces for customers USR, bankers BK, and other administrators.

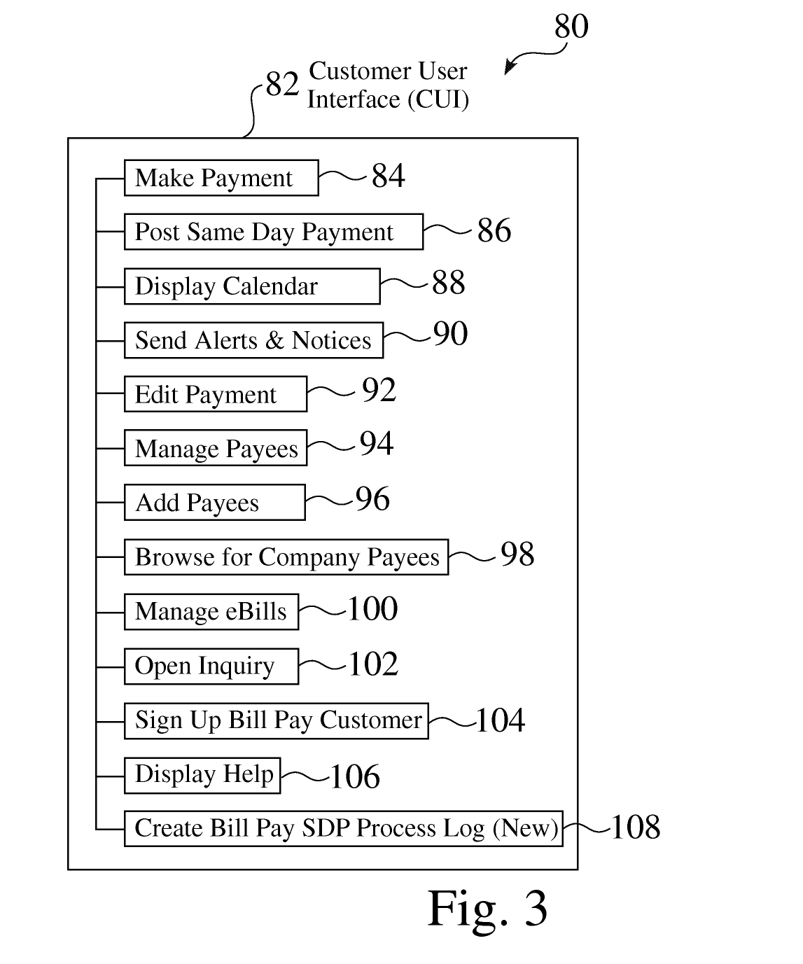

For example, FIG. 3 is a schematic block diagram 80 of a customer user interface (CUI) 82 for a same day payment system 12 implemented within an online banking system network 10. The enhanced customer user interface 82 typically comprises a wide variety of displays, functions and/or controls, such as but not limited to Make Payment 84, Post Same Day Payment 86, Display Calendar 88, Send Alerts & Notices 90, Edit Payment 94, Manage Payees 94, Add Payees 96, Browse for Company Payees 98, Manage eBills 100, Open Inquiry 102, Sign Up Bill Pay Customer 104, Display Help 106, and Create Bill Pay SDP Process Log (New) 108.

Features of the Enhanced Customer User Interface. The enhanced customer user interface 82 allows a customer user USR to request and process a same day payment, using a funding account 742 associated with the user USR, which is currently limited to a customer's demand deposit funding accounts 742.

The user selection, i.e. option, to request a same day payment is clearly delineated from other types of payments, so that there is no confusion on the part of the online banking and payment customer USR that a same day payment is selected, and that an associated transaction fee 750 is to be charged.

The enhanced customer user interface 82 typically comprises means for informing an online banking and payment customer USR that a payee 18 is eligible for a same day payment 744.

The enhanced customer user interface 82 also typically includes a summary of transaction charges and terms of use for the same day payment product, including transaction fees, availability and cut-off times before checkout of same day payment transaction.

The enhanced customer user interface 82 sends a real-time transaction 28 (FIG. 1) to the account product services (APS) 148 (FIG. 12), to check for available funds 754 (FIG. 17) from an account of choice 742 associated with the customer user USR, for the transaction amount 744, plus a transaction fee 750, if applicable. The customer user interface 82 may trigger overdraft protection if available, and/or may fail a requested transaction for non-sufficient funds (NSF).

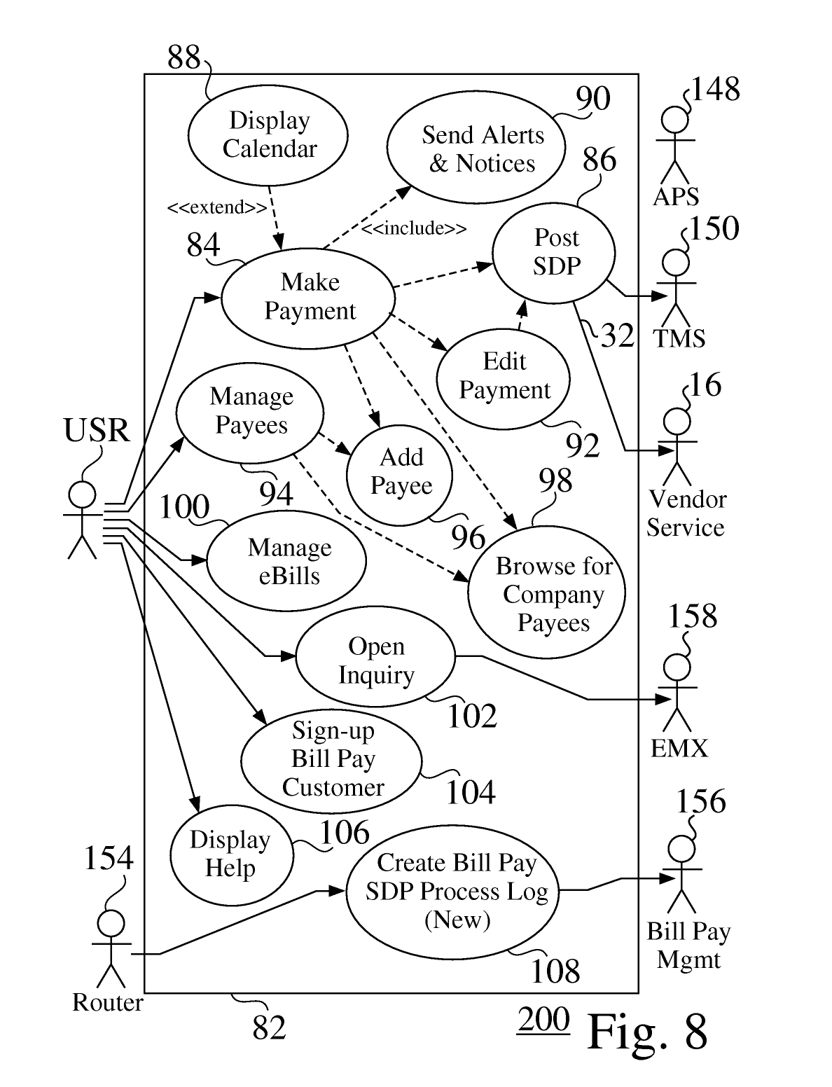

As also seen in FIG. 8, the same day payment system 12, such as through the enhanced customer user interface 82, sends 32 (FIG. 1) a real-time transaction to the vendor service 16 to post 86 a same day payment 744 (FIG. 18). Upon receipt 40 of a successful vendor acknowledgement 26, a real-time transaction 40 is sent to the transaction management services (TMS) module 150, to post two debits to the customer's funding account 742 (FIG. 17, FIG. 18), e.g. a demand deposit (DDA) account 742 (to credit the funding account 742 for the transaction amount 744 and the transaction fee 750), to facilitate fee income reporting, and to allow for the reversal of the fee if appropriate. In current system embodiments 10, the transaction fee 750 is debited from same account 742 as the transaction amount 744.

The transaction and history are also updated to indicate payment status, payment type and the vendor acknowledgement number 36 (FIG. 1). The customer USR receives an acknowledgement in real-time, or near real-time, such as in the form of instant alerts and session notices, that the payment 744 has been received by payee 18, when the same day payment will post or has already been posted to the payee 18, and/or the possibility of failure. The acknowledgement 36,40 includes an acknowledgement number 36 supplied by and associated with the vendor service 16, e.g. Western Union. If the transaction fails, the customer USR is notified of the failure, and the reason for failure.

The same day payment system 12 preferably ensures that the same day payments do not exceed transaction limits. As well, the enhanced customer user interface 82 typically includes:
a customer terms of use disclosure related to same day payments, product as required by legal guidelines including transaction fees, availability and cut-off times; and
waiver language as necessary to denote no waivers of liability for same day payments.

In some embodiments of the same day payment system 12, the transaction charge, e.g. 750, associated with same day payments is flexible, such as to charge different rates per transaction based on any of industry, payee type or specific payee.

In embodiments of the same day payment system 12 that provide conventional online banking and payments as well as expedited, i.e. same day, payment services, customer users USR may have one or more charges waived for different services. For example, in some embodiments 12, customers USR may have some charges waived for standard online payment, while charges are not waived for same day payments 744.

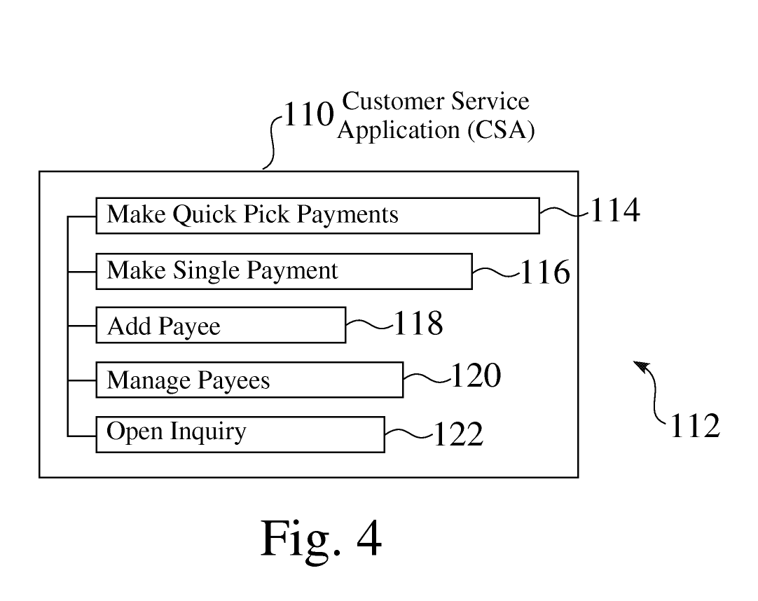

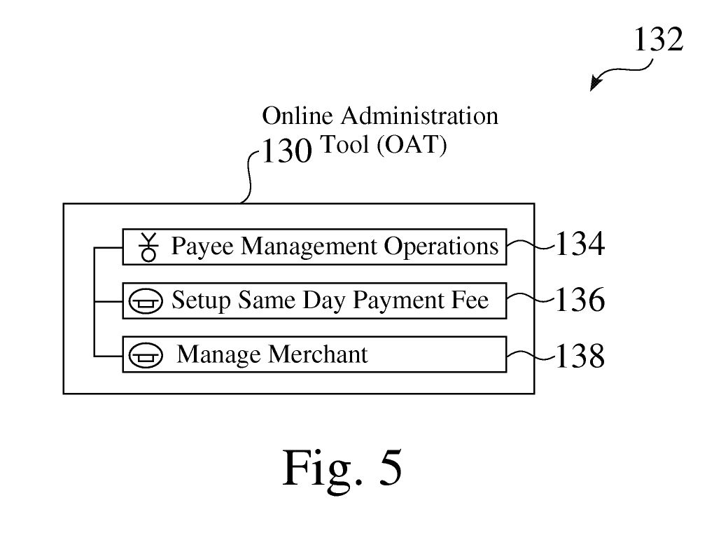

In the same day payment system 12, help information, e.g. such as accessible through links and/or context-sensitive help, is preferably included for the customer user interface 82, as well as for the customer service application 110 (FIG. 4), and for the banker/online administration tool (OAT) 130 modules (FIG. 5). Information is also preferably included for the customer USR in regard to the types of customer accounts that are acceptable for funding same day payments 744, such as for system embodiments that only accept demand deposit (DDA) funding accounts for same day payments 744.

The same day payment system 12 also provides a wide variety of data, such as for monitoring and/or reporting for the vendor service 16, e.g. such as may be required by an external vendor service 16.

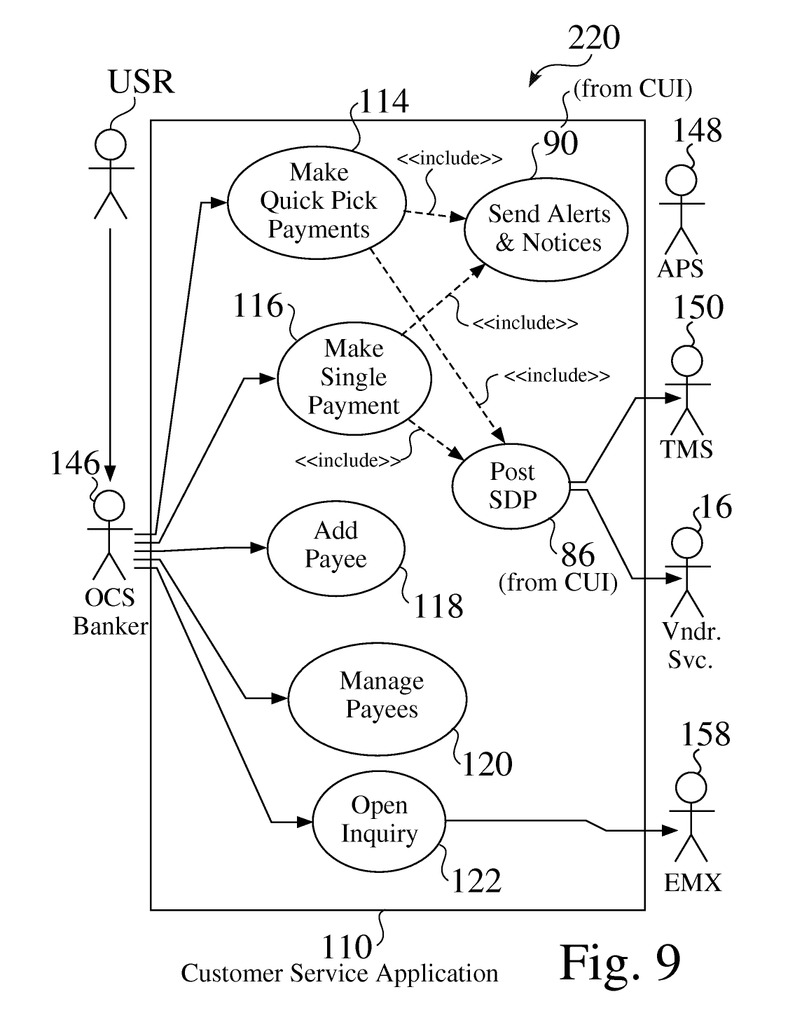

FIG. 4 is a schematic block diagram 112 of an exemplary customer service application (CSA) 110 for a same day payment system 12 implemented within an online banking system network 10. The enhanced customer service application 110 typically comprises displays, functions and/or controls, whereby a banker BK, such as an online customer service banker 146 (FIG. 6, FIG. 9), may interact with the same day payment system 12. The exemplary customer service application 110 seen in FIG. 4 comprises a Make Quick Pick Payments control 114, a Make Single Payment control 116, an Add Payee control 118, a Manage Payees control 120, and an Open Inquiry control 122.

The enhanced customer service application 110 allows bankers BK to perform a wide variety of tasks, such as but not limited to any of the following:
tracking and monitoring same day payment transactions;
controllably reversing a transaction fee for a particular transaction;
making same day payments on behalf of a customer;
distinguishing between same day payments and other payment types; and/or
determining whether a payee is eligible for a same day payment.

FIG. 5 is a schematic block diagram 132 of an exemplary online administration tool (OAT) 130 for a same day payment system 12 implemented within an online banking system network 10, which comprises Payee Management Operations 134, which can controllably interact with Setup Control 136 for a Same Day Payment Fee, and with Merchant Management 138. The online administration tool 130 allows a banker BKR, such as a Payee Management Operator 134, to review and approve billers 18 from a list of eligible billers 18 provided by the vendor service 16, as well as set the transaction fee for one or more same day payments 744.

The enhanced online administration tool (OAT) 130 therefore allows a banker BKR, such as a Payee Management Operator 134, to perform a wide variety of tasks, such as but not limited to any of the following:
selection, approval and/or and association of billers 18 provided through the vendor service 16 to bank payees.
setting transaction fees for same day payments; and/or
activating or inactivating eligible billers 18 from a list of eligible billers 18.

While some embodiments of the same day payment system 12 may be implemented independently of an online banking system, a current embodiment of the same day payment system 12 is integrated with an online banking system 302 (FIG. 12, FIG. 13), and/or within an online payment system 12, such as integrated with Online Banking and Bill Pay for Wells Fargo Bank. In such an integrated online banking and payment structure, a Bill Pay customer USR can readily choose to establish one or more billers 18 for either standard or expedited online payments.

For example, a customer USR may have an established list of creditors, i.e. billers 18 that are commonly paid through an established online payment system, e.g. 302, such as but not limited to mortgage lenders, loans, credit cards, utilities, stores, services, memberships, and/or other eligible payees. In addition to periodic payment of one or more billers, many customers USR occasionally desire expedited payment to one or more billers 18.

Some embodiments of same day payment system 12 are therefore integrated within an online payment system 12, such that a user USR can interact with the enhanced customer user interface 36, e.g. as displayed through a customer browser 58 at a customer terminal 14, to select and make a same day payment to a biller 18, such as approved by the bank, e.g. Wells Fargo, and indicated as eligible by the vendor service 16, e.g. Western Union. As noted above, the expedited payment 744 may include an additional fee 750, which is typically charged to the same account 742 as the account 742 used to pay the biller 18.

As noted above, the same day payment system 12 provides real-time messaging between the bank entity, e.g. Wells Fargo, and the vendor service 16, e.g. Western Union, to request same day payments, and to receive acknowledgement of payments to a biller 18 that is identified as being eligible by the vendor service 16.

The vendor service 16 typically provides and/or updates a list of eligible billers 18 on a periodic basis. The vendor service 16 also preferably provides customer service support, wherein bankers BK can directly monitor and track real time same day payment transactions 744 at the vendor service 16.

Through the enhanced customer service application 110, such as accessed though a banker browser 66, bankers BK can monitor and track same day payments 744, and can also make same day payments 744 on behalf of a customer USR, such as while providing customer service at a bank location or over the phone.

The same day payment system 12 typically verifies available funds 754 in the customer's funding account, e.g. a demand deposit (DDA) funding account 742, before proceeding with a same day payment, such as through a real time call to Account Product Services (APS) 148 (FIG. 12).

The same day payment system 12 also typically sends a real time call to a transaction management services (TMS) module 150 (FIG. 12), to post two memo transactions to debit funds from the customer's demand deposit (DDA) funding account 742, for the payment amount 744, and for the associated transaction fee 750.

The transaction management services 150 follows up with batch hard post transactions at end of each day, to confirm the real time memo posts to the customer's demand deposit (DDA) account 742.

The credit sides of the transactions 744,750 are typically aggregated through an online transactions/dollar processing system (OT/DZ) 312 (FIG. 12, FIG. 13), with single postings to the wholesale demand deposit (DDA) account 330 (FIG. 12), and a wholesale GL account 332 (FIG. 12), for the transaction amount and fee, respectively.

The same day payment system 12 also typically provides reports, as well as modifications to existing reports, to support daily settlement and reconciliation between the Accounting & Control for the same day payment system 12 and the vendor service 16, e.g. Western Union.

Some embodiments of the same day payment system 12 allow bankers to track and research claims for same day payments, and to identify a vendor service 16 as a new online payment processing endpoint for claims resolution.

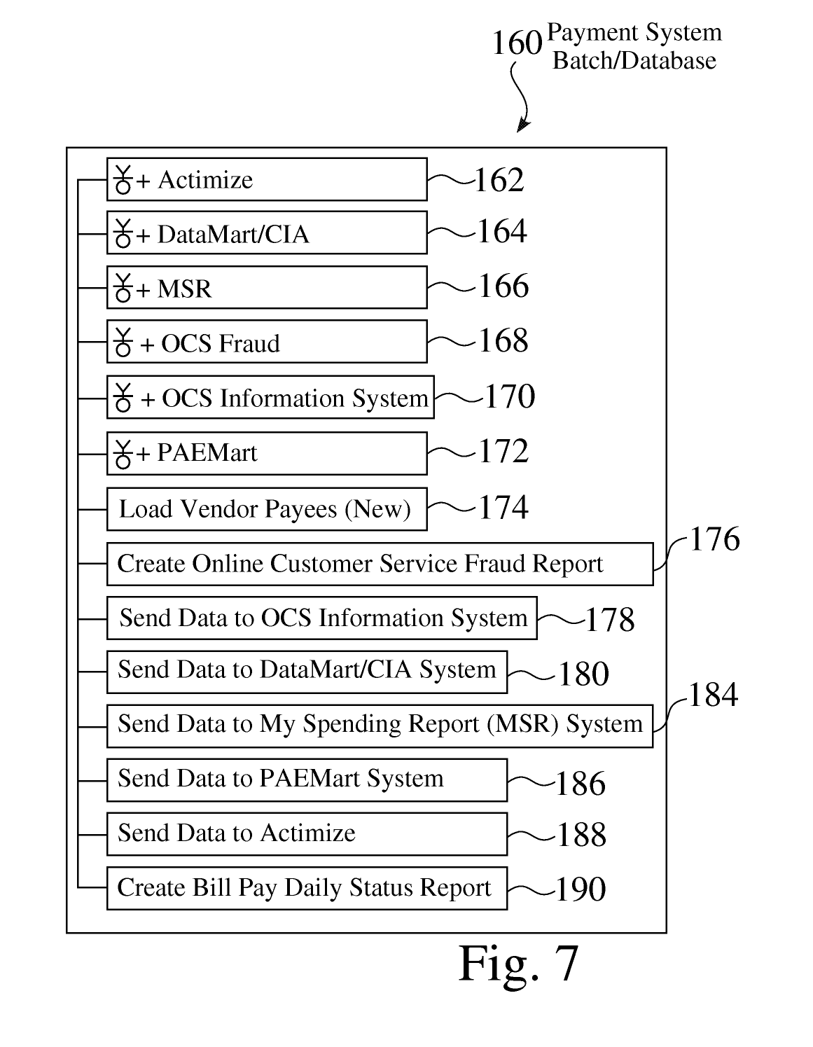

The same day payment system 12 also preferably comprises other processes and reporting that are preferably integrated with other online banking and payment processes and structures, such as but not limited to supporting same day payments within batch processing, supporting data source reporting, e.g. such as through DataMart/CIA 180 (FIG. 7), My Spending Report™ (MSR) 184 (FIG. 7), and/or PAEMart 172 (FIG. 7), and providing fraud reports for banker initiated same day payment transactions.

While different embodiments of the same day payment system 12 provide a wide array of functionality, some current embodiments 12 are specifically adapted to existing payment and account environments.

For example, in a same day payment system 12 integrated within an online banking and payment system structure, e.g. 302 (FIG. 12) for a bank, e.g. Wells Fargo, some payees are typically directly associated with the bank, e.g. Wells Fargo payees 18, wherein same day payments can currently be done through an account transfer process. Therefore, such internal payees may preferably not be eligible to be paid through the same day payment 12 that includes payment through the vendor service 16.

As well, in current embodiments of the same day payment system 12, same day payments cannot be reversed or edited by either the customer USR or by a banker BK. Furthermore, in current embodiments of the same day payment system 12, same day payments are always processed in real-time with the vendor service 16, e.g. Western Union, and cannot currently be scheduled to be processed on a future date.

In addition, while the same day payment system 12 can be implemented in connection with a wide variety of funding accounts 742 associated with a customer user USR, current embodiments of the same day payment system 12 are currently limited to demand deposit accounts (DDA) 742.

The expedited, i.e. same day, payment system 12 provides a great value for customers USR, with an enhanced customer user interface (CUI) 82 through which expedited payments 744 are readily handled through a readily understandable and intuitive interface structure.

Exemplary System Functionality. FIG. 6 is a schematic block diagram 142 of same day payment system actors 140 for a same day payment system 12 implemented within an online banking system network 10. For example, the exemplary actors seen in FIG. 6 comprise a Bill Pay Customer Actor 144, an Online Customer Service Banker Actor 146, an Account Product Services (APS) Actor 148, a Transaction Management Services Actor 150, a Vendor Service Actor 152, a Bill Pay Router Actor 154, a Bill Pay Management Actor 156, and an EMX Actor 158.

FIG. 7 is a schematic block diagram of an exemplary batch/database module 160 associated with a same day payment system 12 implemented within an online banking system network 10. The batch system 160 shown in FIG. 7 comprises a variety of functional actors, as well as functional processes. For example, the actors typically associated with the batch system 160 comprise an Actimize Actor 162, a DataMart/CIA Actor 164, a personal spending report actor, such as associated with MY SPENDING REPORT™ 166, available through Well Fargo Bank, an OCS Fraud Actor 168, an OCS Information System Actor 170, and a PAEMart Actor 172. As well, the functional processes associated with the batch system 160 typically comprise:
a creation 176 of an Online Customer Service (OCS) fraud report;
a sending 178 of data to the OCS Information system 304 (FIG. 12);
a sending 180 of data to a DataMart/CIA system 164;
a sending 184 of data to an online reporting system 400 (FIG. 13), e.g. such as through MSR Actor 166;
a sending 186 of data to a PAEMart system 172;
a sending of 188 data to an Actimize system 162; and/or
a creation 190 of a periodic, e.g. daily, payment system status report.

The same day payment system 12, such as through the associated batch module 160, segregates same day payments 744 from other payments 748 (FIG. 17), and ensures that same day payments 744 are not processed in batch. The same day payment system 12 also prevents duplicate payments from being made in same day payments and other batch payments. The batch system 16G typically performs other functions, such as:
calculating settlements and reconciling transactions with the vendor service 16;
providing settlement and reconciliation data for the same day payment system 12 to OCS Information Services 304 (typically daily).
providing same day payment data to DataMart/CIA, MSR, and PAEMart including same day payment type, fee income and fee reversals.
updating a daily batch process logs and online payment daily report to include same day payments; and/or
receiving and loading eligible billers files from the vendor service 16.

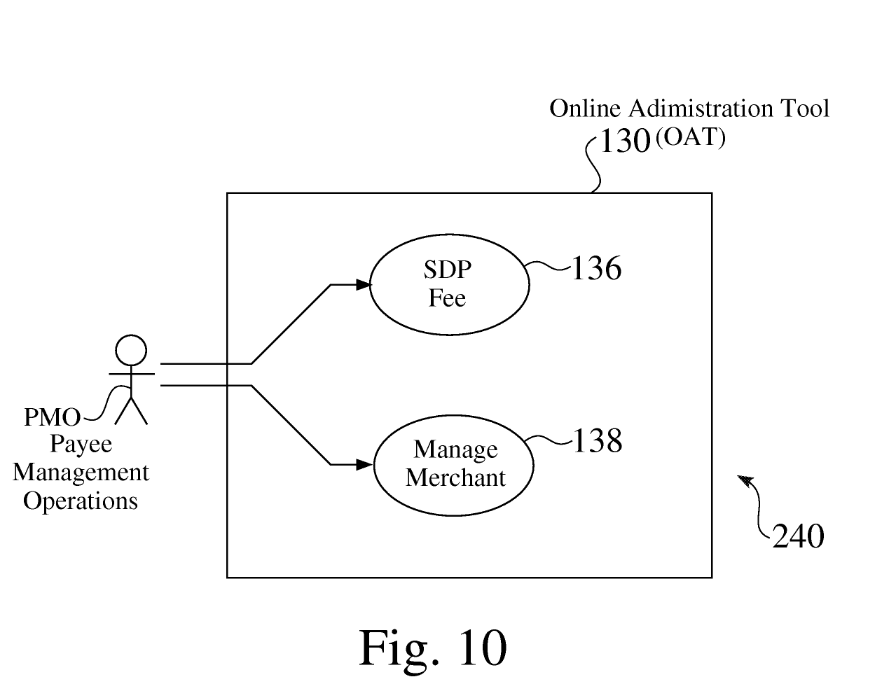

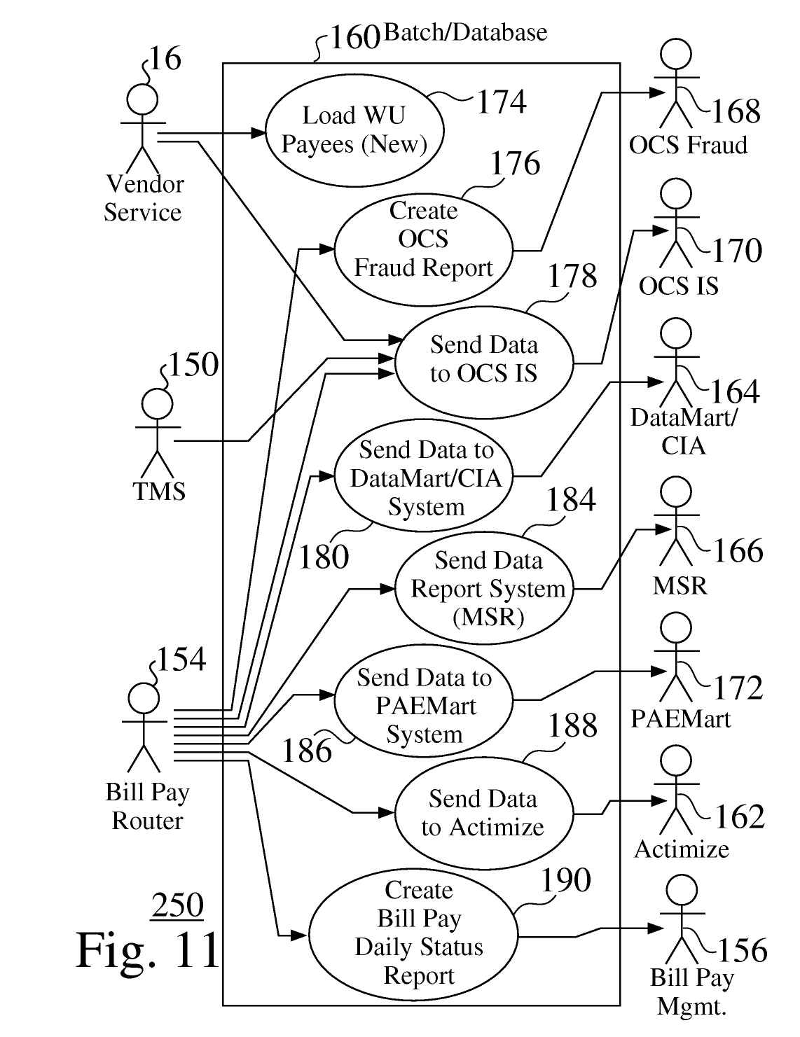

FIG. 8 is a schematic block diagram 200 of interactions associated with a customer user interface (CUI) 82 for a same day payment system 12 within an online banking system network 10. FIG. 9 is a schematic block diagram 220 of interactions associated with a customer service application (CSA) 110 for a same day payment system 12 within an online banking system network 10. FIG. 10 is a schematic block diagram 240 of payee management operations associated with an online administration tool (OAT) 130 for a same day payment system 12 within an online banking system network 10. FIG. 11 is a schematic block diagram 250 of interactions associated with a same day payment system batch system 160 for a same day payment system 12 within an online banking system network 10.

Exemplary System Architecture. FIG. 12 is a system architecture component diagram 300 for an exemplary same day payment system 12 implemented within an online banking system network 10. FIG. 13 is an interaction model communication diagram 360 for an exemplary same day payment system 12 implemented within an online banking system network 10.

In an exemplary login process, as seen in FIG. 13, a customer user USR logs into the enhanced payment system 12, e.g. Bill Pay, through an online banking application 302. A customer USR typically first logs in 362 through a customer browser 58, such as by selecting an online banking system link. The online banking application 302, e.g. Wells Fargo WIB, then sends 366 a list of accounts that the customer USR has to the account product services APS system 148, which verifies which account 742 is valid for online payment funding. The online banking application 302 then sends 368 the funding accounts information to the customer user interface 82 of the enhanced payment system 12, such as through a SAML payload, when the customer clicks on an online payment, e.g. Bill Pay, tab. The customer user interface 82 then stores 370 the funding account information to the payment system database 310, e.g. the Bill Pay database.

In an exemplary same day payment process, a customer user USR initiates one or more expedited, e.g. same day, payments 744. A customer USR typically selects 372 a funding account 742 and a desired payee, i.e. biller 18 that is indicated as being eligible by the vendor service 16, e.g. Western Union, through the customer browser 58, e.g. such as selectable from any of a list, a pull-down menu, selectable radio buttons, or other means.

The customer user interface 82 issues and sends 374 a getAccount message to the account product services (APS) system 148 to get the account detail data, and then verifies the balance on the funding account 742 against the payment 744 and fee 750. The customer user interface 82 also typically verifies the overdraft protection (ODP) account balance if the funding account 742 cannot cover the payment 744 and fee 750. If there are any holds, the customer user interface 82 also calls authorizeAcctsForTransfer.

Through the customer user interface 82, the customer user USR fills in the required fields for same day payment 744, and typically clicks on a submit button 756 (FIG. 17), wherein the payment information is sent 376 to the same day payment library 308. The same day payment library 308 then records 378 the same day payment request 376 at the payment system database 310 with a unique payment ID. The same day payment library 308 calls 380 the vendor service 16, e.g. a computer or server associated with Western Union, to send the payment instruction, and the service 16 returns 38 (FIG. 1) with a confirmation number 36 (FIG. 1).

The same day payment (SDP) library 308 then debits the funding account 742, by calling 382 the transaction management services 150 with a transfer message to move the same day payment 744 and fee 750 from the funding account 742 to wholesale accounts designated through the system 12. The transaction management services 150 then performs two memo post transactions 384 at the online delivery system (ODS) 320, such as with different trancode to IDS for debiting the funding account 742, comprising one post 384 for the expedited payment 744, and the other post for an associated fee 750. On the funding account 742, overdraft protection ODP is triggered if appropriate. If either overdraft protection ODP or non-sufficient funds NSF conditions occur, the system 12 may typically ensure that customer USR is charged for ODP and/or NSF as one transaction.

The transaction management services 150 also send associated credits 386 of the payment 744 and fee 750 to the online transactions/dollar processing (OT/DZ) system 312, for crediting the online payment system wholesale accounts 330,332 (FIG. 12). The online transactions/dollar processing system 312 records each transaction throughout the day (no memo post). The same day payment library 308 updates 388 the payment record at the payment system database 310, with the confirmation number 36 from the external vendor 16 and the transaction management services module 150.

A same day payment process can also be initiated by a banker BK, such as on behalf of a customer USR. Through a banker browser 66, a banker BK inputs 390 the associated payment information into the customer service application 110. The customer service application 110 then loads 392 the funding account and the payee's information from the payment system database 310. The customer service application 110 then validates 394 the funding account 742, by sending 394 a getAccount message to the account product services (APS) system 148 to get the account detail data, and then verifying the balance on the funding account 742 against the payment 744 and fee 750. The customer service application 110 also typically verifies the overdraft protection (ODP) account balance if the funding account 742 cannot cover the payment 744 and fee 750. If there are any holds, the customer service application 110 also calls authorizeAcctsForTransfer.

Through the customer service application 110, the banker BK fills in the required fields for same day payment 744, and typically clicks on a submit button 756 (FIG. 17), wherein the payment information is sent 396 to the same day payment library 308. The payment process then proceeds in a similar manner to a same day payment 744,750 initiated by a customer USR through the customer user interface 82.

While some of the associated processes are described within an online payment system 12 that comprises an enhanced Bill Pay system 12, it should be understood that the structures and processes can be implemented for a wide variety of banking and/or online payment systems.

The enhanced online payment system 12 also comprises structures and associated processes of periodic hard posting, which is typically performed nightly for an expedited payment system 12 that provides same day payments 744. In the exemplary system environment seen in FIG. 13, the online transactions/dollar processing (OT/DZ) module 312 sends 410 a batch file that contains aggregated credits for the day, as well as journals to the GL account 332, to the Non-MICR Electronic Transactions (NMIC) system 314, such as at a given time in the evening. The NMIC system 314 then delivers the file to the data distributor (DE) system module 316, and the data distributor (DE) system module 316 distributes the credit transactions to the online payment wholesale accounts 330,332 in the online delivery system (ODS) 320. The online delivery system (ODS) 320 then performs the hard post 412, such as by running a “memo to capture” batch job at night, to hard post all debit transactions.

Settlements. The exemplary enhanced online payment system 12 seen in FIG. 13 also comprises settlement structures and associated processes. For example, at a defined cut off time, the batch system 160 retrieves 420 any debit transactions from the payment system database 310 that cannot be delivered to the transaction management services 150 due to system error(s). This step is dependent upon the receipt of error files from the transaction management services 150, and settlement files from the vendor service 16, e.g. an external vendor service 16.

The vendor service 16 typically sends 422 the daily settlement file to the batch system 160, after the cutoff time associated with the vendor service 16. For example, for an external vendor service 16, e.g. Western Union 16 having a cutoff time for payments of 8:00 PM PT, the external vendor service 16 may preferably send 422 the daily settlement file to the batch system 160 at around 8:30 PM Pacific Time.

At a cut off time associated with the online transactions/dollar processing (OT/DZ) module 312, the transaction management services 150 generates an error file associated with rejected debit transactions, and sends 424 the file to the batch system 160, wherein the file contains any error transactions that cannot be retried, or retried after a maximum allowed.

The batch system 160 then processes all items sent 422 from the vendor service 16 and debit rejects from any of the payment system 12, the transaction management services 150, and the online transactions/dollar processing module 312. The batch system 160 then constructs an external vendor settlement report and delivers 426 the settlement report to the online reporting system 400, such as for online customer service (OCS) accounting to work on settlement audits.

In some system embodiments 12, the batch system 160 receives two flat files from the transaction management services system 150, comprising both the TMS reject file and the vendor service settlement file. The files are typically sent each evening, such as after the 8:00 p.m. settlement cut-off time. The batch system 160 then generates two new flat files, such as on a daily basis for associated Information systems IS, comprising:
a same day payment/external vendor settlement file; and
a same day payment reconciliation file.

These files are used to generate external vendor settlement reports for Online Customer Services 304 (FIG. 12), such as for accounting and control.

TMS Rejects Files. A TMS rejects file is generated by the transaction management services system 150, and is sent 424 to the online payment system 12, typically at the end of each business day. The TMS rejects file contains rejected transactions only, and one record per payment.

A rejected transaction from the online delivery system (ODS) 320 means that the debit was not posted to the customer's account 742, and the credit was also not posted in the online payment system accounts. A rejected transaction from the online transactions/dollar processing module 312 means that a debit to the customer's account was successful, but the associated credit to the online payment system accounts 330 and/or 332 was not successful.

An exemplary TMS rejects file may preferably comprise information regarding rejected same day payments 744, as well as header information and footer information. An exemplary TMS reject file header may comprise information about the file, such as its creation date. For example, a sample header may be ‘H20060818’, where first field element “H” may denote the contents, while fields 2-9 correspond to the date, e.g. having a format of “CCYYMMDD”. The detail records hold information regarding rejected same day payments, such as comprising any of record type, account number, reference number, Application ID, Payment ID, Vendor confirmation number, return code, return reason, and system, e.g. indicating the system where the reject occurred, such as “0” for a rejection that occurred at the online delivery system (ODS) 320, and “D” for a rejection that occurred at the online transactions/dollar processing module 312. A TMS rejects file typically holds counts on the number of records, wherein the footer information is used to confirm file validity. For example, a sample trailer may be “T200608180000271”, where the first field element “T” may denote the record type, where fields 2-9 correspond to the return date, e.g. having a format of “CCYYMMDD”, and where fields 10-17 provide a numeric record count.

Vendor Service Settlement File Details. Settlement files are typically received 422 from the vendor service 16, e.g. Western Union, on a daily basis, and are processed by the enhanced payment system 12. The settlement file contains one record per successful payment posted to the vendor service 16. Settlement files are currently flat files, and are currently transferred by NDM, after a settlement cut-off time, which is currently 8:00 p.m. Pacific Time.

An exemplary vendor settlement file may preferably comprise information regarding rejected same day payments 744, as well as header information and footer information. The file header currently holds information about the file, such as record type and settlement date. For example, a sample header may be ‘H20061118’, where first field element “H” may denote the record type, while fields 2-9 correspond to the date, e.g. having a format of “CCYYMMDD”. The detail records hold information regarding rejected same day payments, such as comprising any of record type, Payment ID, Customer ID, Vendor Confirmation Number, Biller ID, Payment Amount, Debit/Credit, and Return Reason Code. A vendor settlement file record currently holds counts on the number of records, wherein the footer information is used to confirm file validity. For example, a sample trailer may be “T0000271000000000000271 . . . ”, where the first field element “T” may denote the record type, while subsequent fields may denote any of debit record count, credit record count, total record count, and debit amount total.

OCS Vendor Settlement Tables. As noted above, external vendor settlement tables are currently extracted 420 from the payment system database daily and are sent to the OCS system 304, such as to the online reporting system 306,400. The external vendor settlement tables contain one record per same day payment sent to the external vendor 16 for the particular settlement day. The file contains one record per payment, and may have different defined layouts for settled payments and unsettled payments. The files may typically include a section name value, such as having:
a code value of ASST (All Sponsor Settlement Transactions), denoting a payment settled at the vendor service, e.g. external vendor 16;
a code value of PSNM (Payment Sent Not Matched), denoting a payment that doesn't match with that in the payment system 12;
a code value of PSCN (Payment Sent Cancelled), denoting that a payment was sent but not acknowledged by the vendor service 16 and cancelled;
a code value of ADMN (Amount Do Not Match), denoting that a payment amount doesn't match with that in the payment system 12;
a code value of MDST (Multiple Debits for same Transaction), denoting a payment that exists in the system 12 but is a duplicate; and
a code value of PNSS (Payments not in Sponsor Settlement), denoting a payment in the payment system 12 and not settled at the vendor service 16.

Updating Eligible Payee List. A list of eligible payees 18 is typically provided to the enhanced payment system 12, wherein the list is periodically refreshed. For example, as seen in FIG. 13, the external vendor 16 sends 430 a list of payees 18 to the batch system 160, such as at a set frequency. The batch system 160 stores 432 the new/refreshed payees list to the system database 310. The batch system 160 also prepares a payee change report, and sends 434 the payee change report associated with the vendor service 16, e.g. an external vendor 16, to the online reporting system 400, such as for use by online customer service (OCS) Payee Management.

As also seen in FIG. 13, a payment system administrator PMO may access 440 the enhanced payment system through the online administration tools interface 130, such as to set 442 payees associated with the external vendor service 16, after receiving a change report from step 434. Through the online administration tools interface 130, a payment system administrator PMO may also typically set 442 account masks, and/or fees(s) 750 for same day payments 744. Updates through the online administration tools interface 130, such as comprising any of the vendor payees list, account masks, and/or same day payment (SDP) fees are updated 442 to the payment system database 310.

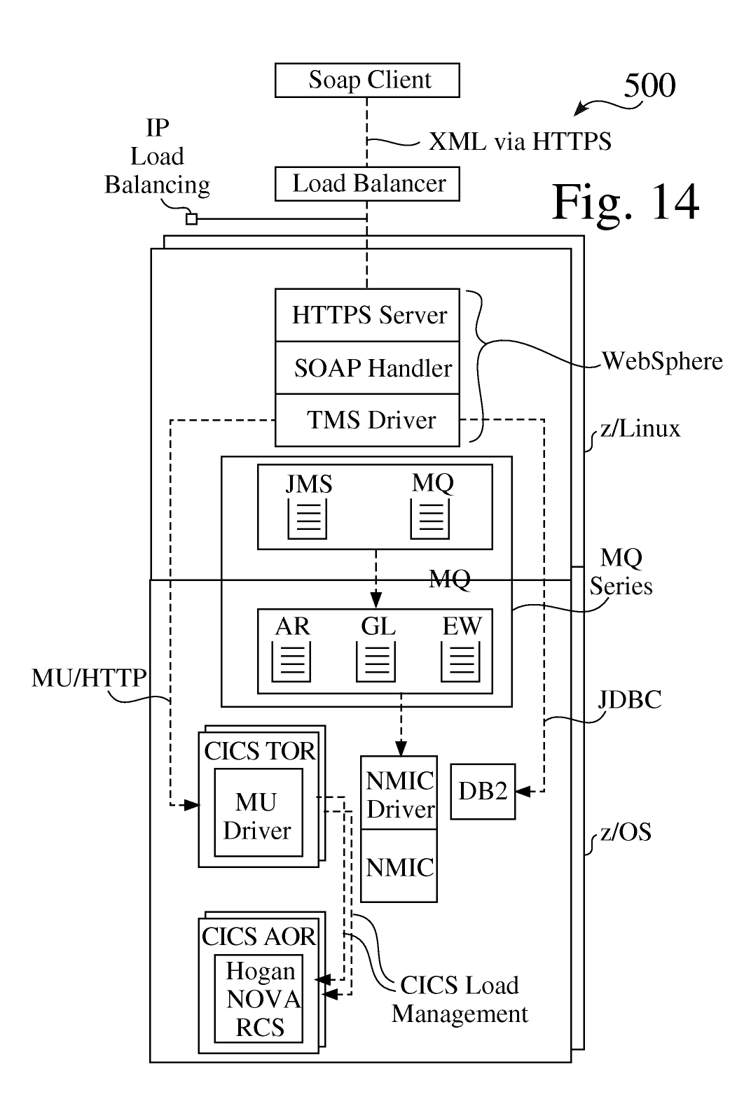

FIG. 14 is a functional schematic diagram of an exemplary load balancing structure 500 for a same day payment system 12 implemented within an online banking system network 10.

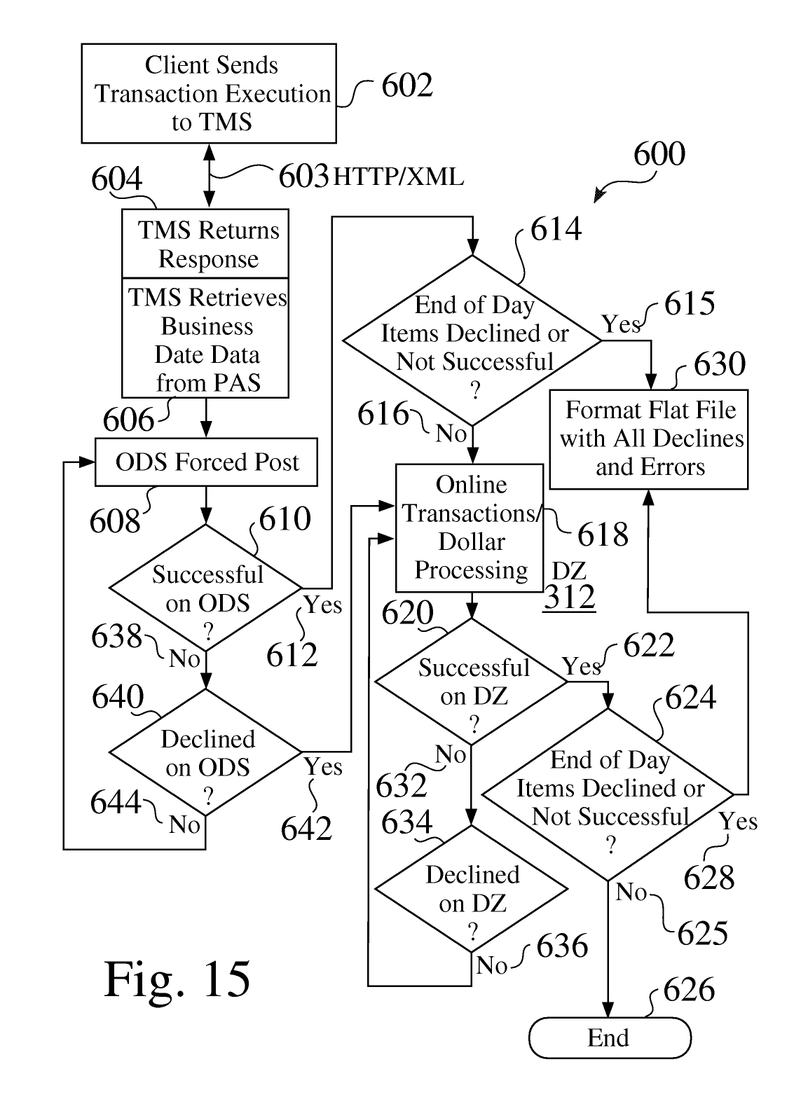

Exemplary Same Day Payment Process. FIG. 15 is a flow diagram for an exemplary same day payment process 600 implemented within an online banking system network 10.

As seen in FIG. 15, a client communicates with the transaction management services 150, such as using XML over an HTTPS secure socket link. The client e.g. the online payment system 12, sends 602 a transaction execution to the transaction management services 150. The transaction management services 150 then retrieves 606 business date data from platform automation support (PAS), such as supplied by the online delivery system (ODS) 320 (FIG. 12, FIG. 13).

The online delivery system (ODS) 320 is the primary monetary system that provides memo and real-time debit and credit posting. In a current embodiment of the online delivery system (ODS) 320, interfaces comprise Hogan AMF, RST, CIS, and Shaw Intraday.

The transaction management services system (TMS) 150 is a business service provider of common monetary transaction services for monetary transactions from multiple channels. The transaction management services 150 supports input from a wide variety of channels, and provides consistent servicing for any of:
enhancing the customer experience;
controlling fraud;
ensuring posting efficiency;
considering feasibility of consolidation of systems/processes; and
supporting Balance Sheet Engineering (BSE) initiatives.

### Source applications or clients utilize an orchestrator portion of the transaction management services 150 to get real-time information, and to memo or post in real time.

The transaction management services 150 typically accesses the platform automated support (PAS), such as supplied by the online delivery system (ODS) 320, for read-only account detail, i.e. account data that is not associated with a monetary transaction.

For other systems, the platform automated support (PAS), such as supplied by the online delivery system (ODS) 320, is the primary interface to other system information systems, e.g. CIS, providing services such as customer and account inquiry and maintenance. PAS interfaces include Hogan AMF, PI, and Shaw as well.

As seen in FIG. 15, a forced post is initiated 608 through the transaction management services 150 at the online delivery system (ODS) 320. Forced posts are typically processed in transaction management services 150 without the validation or decision checks that are normally made prior to posting. Item codes are typically used to identify items sent to the online delivery system (ODS) 320. This code controls the decline criteria that are used to validate whether an item is okay to post, and also controls the trancode that is used in online delivery system (ODS) history.

If next business day processing applies, the initiated post 608 is flagged to indicate this. A determination 610 is then made whether the forced post is successful 612 on the online delivery system (ODS) 320. If not 638, a determination 640 is made whether the transaction is declined 642 on the online delivery system (ODS) 320. If not 644, the transaction is returned to step 608. If past the daily cut-off time, e.g. 8 p.m. Pacific on a business day, the transaction is reported as an error instead. If the transaction is declined 642 on the online delivery system (ODS) 320, the transaction is flagged as declined, and sent to the online transactions/dollar processing system 312.

The online transactions/dollar processing system 312, which may alternately be referred to as the OT/DZ (or DZ), is typically a mainframe application for handling funds transfer transactions initiated from various channels. For example, the online transactions/dollar processing system 312 can transfer funds within the host financial entity, e.g. Wells Fargo. Bank, or externally to other financial institutions, via an automated clearing house.

If the determination 610 whether the forced post is successful 612 on the online delivery system (ODS) 320, a determination 614 is then made whether end of day items are declined or not successful 615, in which case a flat file is formatted 630, with all declines and errors. If the determination 614 is negative 616, the transaction is sent to the online transactions/dollar processing system 312. If next business day processing, the process sends the next business date as the post date.

As seen in FIG. 15, a determination 620 is made whether a transaction is successful on the online transactions/dollar processing system 312. If not 632, a determination 634 is made whether the transaction is declined on the online transactions/dollar processing system 312. If not 636, the transaction is returned, i.e. retried at the online transactions/dollar processing system 312. If past the daily cut-off time, e.g. 8 p.m. Pacific on a business day, the transaction is reported as an error instead.

If the determination 620 is successful 622 on the online transactions/dollar processing system 312, a determination 624 is then made whether end of day items are declined or not successful 628, in which case a flat file is formatted 630, with all declines and errors. If the determination 624 is negative 625, the process is ended 626.

In the exemplary process 600 shown in FIG. 15, the customer USR is typically processing a same day payment transaction. The payment system 12 interfaces with the vendor service 16, e.g. Western Union, for the payment portion of the transaction. If confirmation of payment is successfully received by the online payment system 12, then:
the payment system 12 passes two same day payment items to the transaction management services module 150, e.g. such as comprising a debit to the customer demand deposit account (DDA) 742 for payment amount 744, and a debit to the customer demand deposit account (DDA) 742 for a payment fee 750.
the transaction management services module 150 passes both items for processing in the online delivery system (ODS) 320. If the transaction is declined by the online delivery system (ODS) 320, the transaction management services 150 will pass the transaction to the OT/DZ 312 as a decline. If any other error occurs, the transaction management services 150 will re-attempt online delivery system processing, e.g. every 30 minutes, until successful, or until the 8:00 PM cut off time. If the items are not processed before the cut off time, the transaction management services 150 will report the error.
the transaction management services module 150 passes both items for processing in Dollar Processing DZ 312. If any error occurs (other than a decline error), the transaction management services 150 will re-attempt DZ processing, e.g. every 30 minutes, until successful or until the 8:00 PM cut off time. If the items are not processed before the cut off time, the transaction management services 150 will report the error.
the OT/DZ 312 creates an aggregate post to the wholesale demand deposit account (DDA) 330 to offset debits to the transaction management services settlement account.
the OT/DZ 312 creates an aggregate post to the wholesale GL fee account 332 to offset debits to the transaction management services settlement account 330.
after the 8:00 PM cut off time, the transaction management services module 150 creates a flat file report of declines and failures for the current business day.
during batch processing at the online delivery system (ODS) 320, IDS hard posts same day payment amount and fee debits for the current business day to the customer DDA 742.

Exemplary Expedited Payment System Architectures. The exemplary enhanced payment system 12 seen in FIG. 12 and FIG. 13 interfaces with the transaction management services 150 for same day payments 744. The enhanced payment system 12 calls the account product services (APS) 148, e.g. getAccount, to complete account validation prior to sending a same day payment transaction to the transaction management services 150. The enhanced payment system 12 preferably ensures receipt of payment confirmation from the service vendor 16, e.g. Western Union, prior to sending a same day payment transaction to the transaction management services 150. In current system embodiments, the enhanced payment system 12 does not wait for a successful response from the transaction management services 150 prior to responding to the customer USR, even though the payment system 12 waits for the TMS acknowledgement.

The transaction management services (TMS) system 150 typically returns response codes, e.g. ISO codes, in regard to transaction status, such as comprising:
an ISO response code of “30” for formatting errors;
an ISO response code of “96” for system errors that would prevent TMS from guaranteeing delivery;
an ISO response code of “00” to acknowledge that TMS has received the same day payment transaction; or an ISO response code of “96”.

If the transaction management services 150 returns an ISO response code of “96”, or if the enhanced payment system 12 times out while waiting for TMS acknowledgment, the enhanced payment system 12 will currently make two more requests. If still unsuccessful, the enhanced payment system 12 will currently retry at 30 minute intervals.

The transaction management services 150 currently uses IP filtering and HTTPS to verify and secure requests from the enhanced online payment system 12, e.g. Bill Pay 12. Transactions that are passed to any of the online delivery service 320 and the online transactions/dollar processing system 312 are currently processed on the transaction management services 150 using guaranteed delivery, wherein the transaction management services 150 will continue posting a transaction until it posts successfully, or until the cut off time is reached. If a transaction fails to post before the cut off time, it will be reported as an error.

Currently, transactions are posted to the online delivery service 320 prior to posting to the online transactions/dollar processing system 312. As well, transactions that are declined by the online delivery service 320 are currently passed to the online transactions/dollar processing system 312 as declined. Items posting to the online delivery service, e.g. Hogan, are currently processed in the transaction management services 150 using forced post processing, wherein no validation or decision is performed in the transaction management services 150 prior to posting.

In current system embodiments 12, items posting to the online delivery service 320 are memo-to-capture, i.e. the items are memo posted in real time, and then batch processed later as hard posts by the online delivery service 320, e.g. Hogan.

An existing transaction code, e.g. a Hogan Bill Pay trancode, is currently used for same day payment amounts 744 and is denoted as a priority pay to ensure that all items are posted in batch. For example, priority pay items are processed first during batch processing in the online delivery service 320, and are not rejected unless a customer account is closed. Another transaction code is used for same day payment fees 750, and is also denoted as a priority pay to ensure that all items are posted in batch.

The exemplary transaction management services 150 seen in FIG. 12 and FIG. 13 interfaces with the online transactions/dollar processing system 312 to complete the aggregate credit to the wholesale demand deposit (DDA) settlement account 330 (FIG. 12) for same day payment amounts, which are processed in the online transactions/dollar processing system 312. The transaction management services 150 also interfaces with the online transaction/dollar processing system 312 to complete the aggregate credit to the payment system fee account 332, e.g. Bill Pay GL fee account 332, for same day payment fees, which are processed in the online transactions/dollar processing system 312.

The transaction management services 150 currently resends failed transactions every 30 minutes, until the cut off time, which is currently 8:00 PM Pacific. Same day payments that have not posted by the cut off time are reported as errors. The transaction management services 150 produces an error file containing all transactions that did not complete successfully in either the online delivery system (ODS) 320 or the online transactions/dollar processing system 312.

The transaction management services 150 writes log records, e.g. such as to BIS, using the client event schema, wherein the log is used to support troubleshooting for the transaction management services 150.

The transaction management services 150 also currently provides current/next business day processing logic using the business day information retrieved from platform automated support (PAS), such as supplied by the online delivery system (ODS) 320 (FIG. 12, FIG. 13).

As noted above, the transaction management services system 150 currently creates a flat file, entitled TMS rejects, to report declines and errors. The error report is preferably transferred daily, e.g. after an 8:00 PM Pacific cut off time, to enhanced payment system 12, e.g. ISG Bill Pay, via Network Data Mover (NDM) and includes:
a header with return date;
a file control ID with account number, reference number, external vendor, e.g. WU, confirmation number, return code, and return reason; and
a footer with return date and record count.

### The transaction management services system 150 currently ensures that all account numbers are limited to no more than 23 characters.

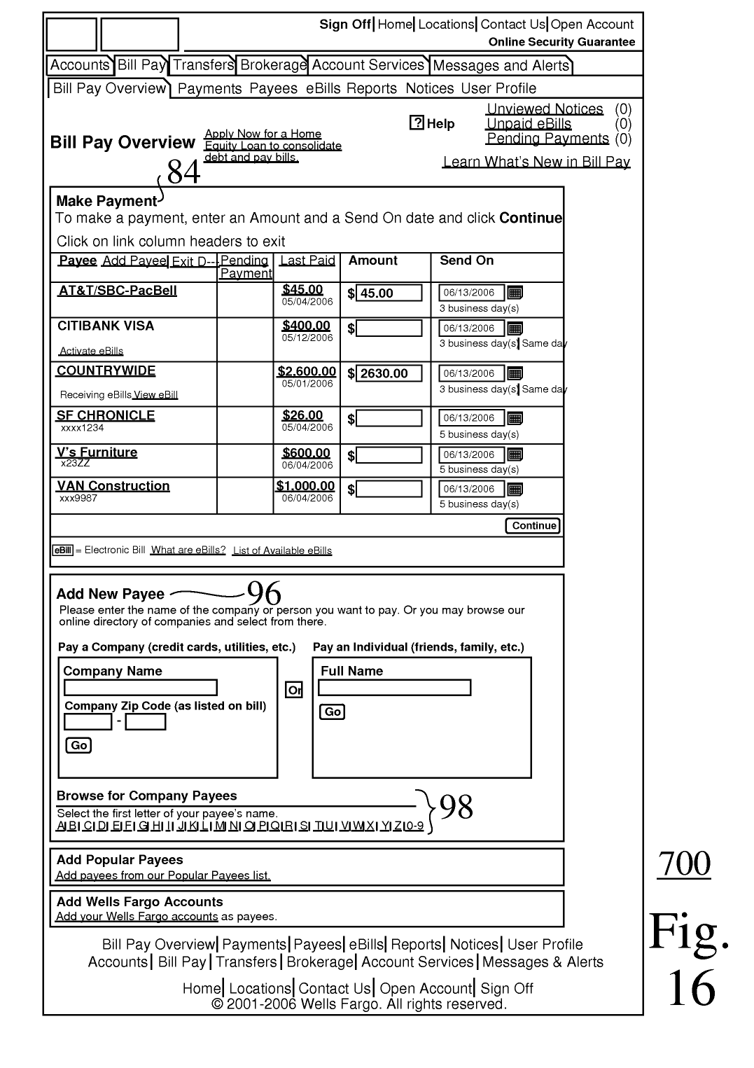

Exemplary Interface Details. FIG. 16 is a screenshot of an exemplary Bill Pay overview screen 700 for a same day payment system 12 implemented within an online banking system network 10, such as comprising make payment controls 84, add payees control 96, and browse payees control 98.

FIG. 17 is a screenshot of an exemplary make payment screen 740 for a same day payment system 12 implemented within an online banking system network 10, such as preferably comprising make payment controls 84 for scheduled online payments 748 and/or expedited payments 744. As seen in FIG. 17, a user USR can controllably choose payments toward payee, i.e. biller accounts 746, e.g. 746a,746b, associated with billers 18, e.g. 18a, 18b. The exemplary displayed biller 18b, e.g. COUNTRYWIDE, in FIG. 17 represents an eligible biller 18, such that expedited, e.g. same day, payment 744 is selectable, such as for an additional transaction fee of $15.00. As also seen in FIG. 17, a user USR can select one or more funding accounts 742, and can enter a desired payment amount 744, before submitting 756 a payment request.

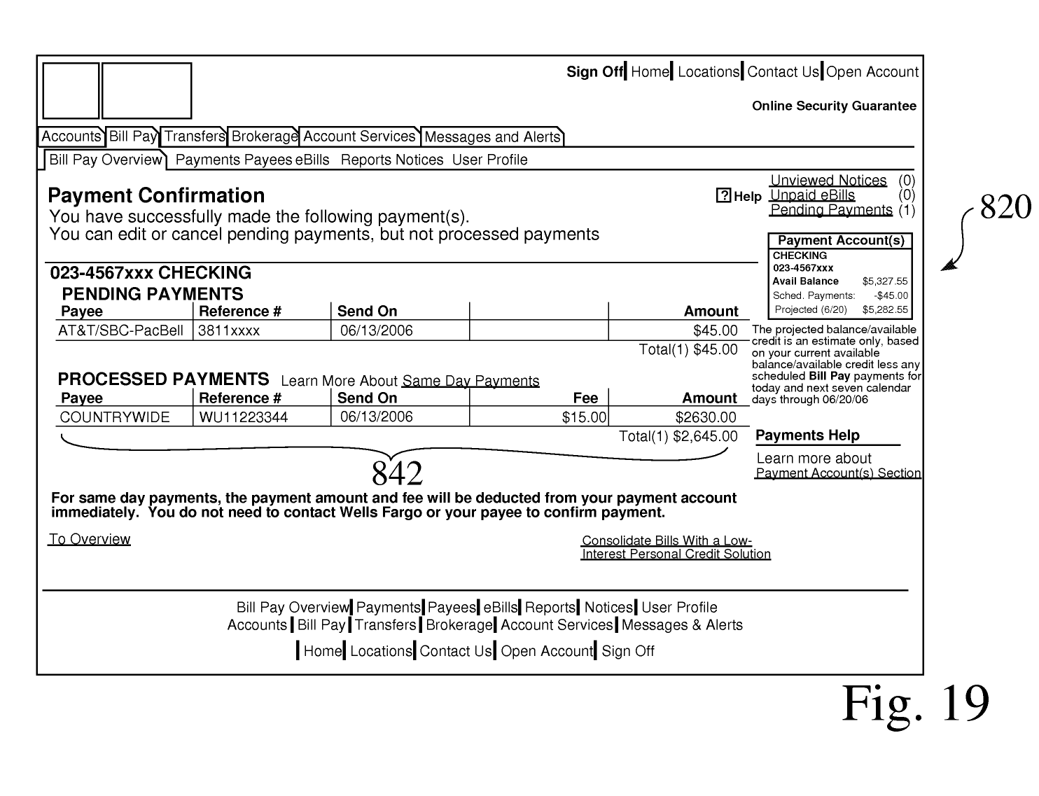

FIG. 18 is a screenshot of an exemplary payment verification screen 780 for a same day payment system 12 implemented within an online banking system network 10. As seen in FIG. 18, a payment verification screen 78 may typically comprise detailed information about one or more requested payment transactions 744, such as before expedited payment submittal 785. FIG. 19 is a screenshot of an exemplary payment confirmation screen 820 for a same day payment system implemented 12 within an online banking system network 10, such as comprising payment confirmations 842 for expedited payments 744, and preferably comprising payment confirmation information for other types of payments, e.g. scheduled payments 748.

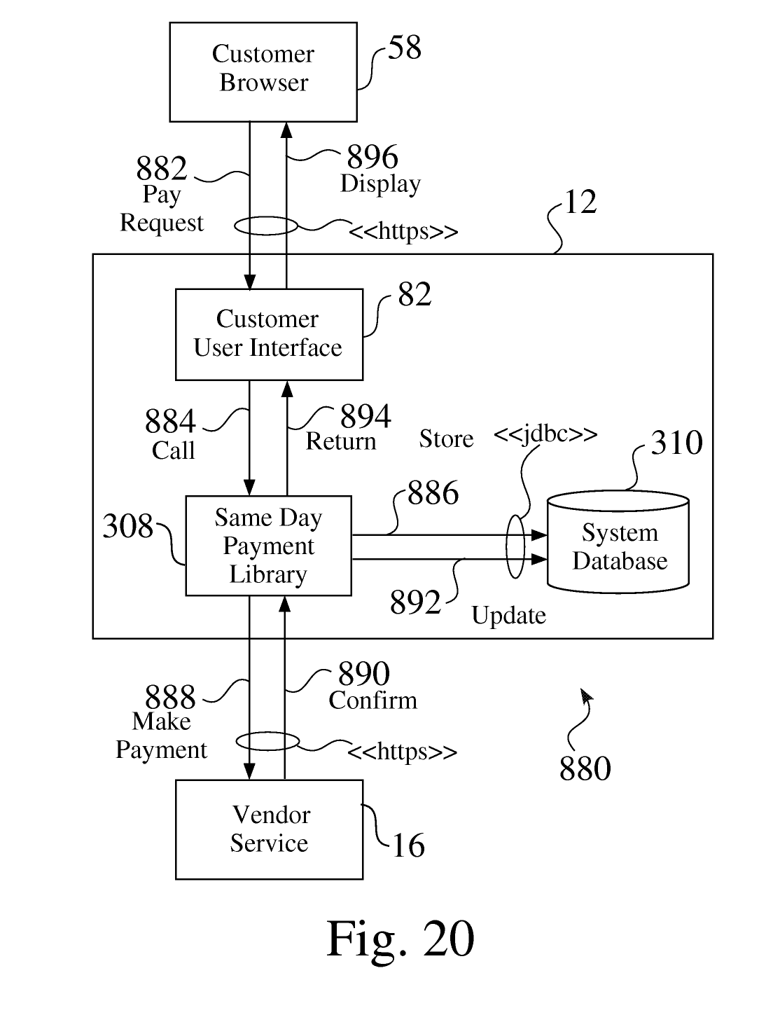

Exemplary System Interactions. There are currently two real time messages to support expedited payment processing in the enhanced payment system 12. One real time message is a “Send Payment Instruction”, which processes a payment request from the requester, e.g. Wells Fargo. The other real time message is a “Reverse Payment”, which reverses a previous successful payment instruction request. FIGS. 20-23 provide communication diagrams the depict the high level process flows.

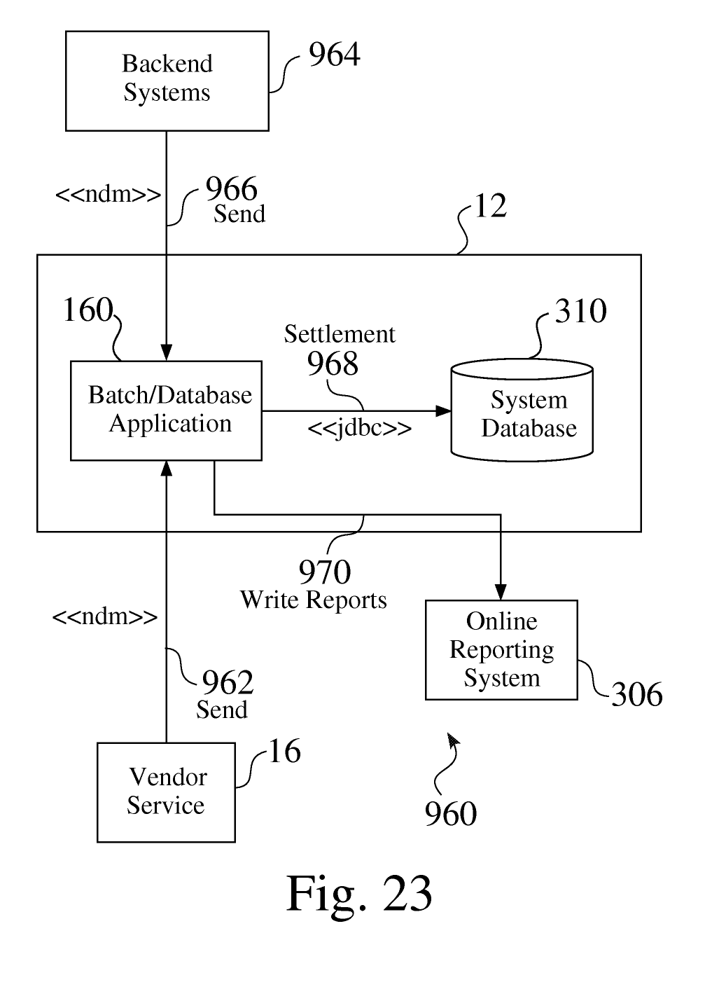

FIG. 20 is an exemplary schematic interaction diagram for the transmission 880 of payment instructions for an enhanced online payment system 12 implemented within an online banking system network 10. A payment request is sent 882 from the customer browser 58 to the customer user interface 82, such as over a secure connection, e.g. https. The customer USR typically selects a same day payment, such as by selecting a funding Account 742, e.g. a Wells Fargo demand deposit DDA account 742, and a vendor service biller 18, then enters a payment amount 744. The payment system customer user interface 82 then calls 884 the same day payment library module 308 with the payment instruction, which triggers the transaction. The same day payment library module 308 stores 886, i.e. inserts the payment information, along with a unique ID, at the payment system database 310, e.g. a Bill Pay database 310, such as over a jdbc connection. The same day payment library module 308 than makes 888 the payment, such as by securely calling the payment instruction web service provided by the vendor service 16. The vendor service 16, e.g. an external vendor 16, then authorizes the payment, notifies the merchant, i.e. biller, and confirms 890 the payment by returning a confirmation number to the same day payment library module 308. The same day payment library module 308 updates the bank back end systems 964 (FIG. 23) to debit the funding account 742, and stores, i.e. inserts 892 the confirmation to the associated payment record at the system database 310. The same day payment library module 308 then returns 894 the confirmation number to the system customer user interface 82, to end the transaction. The customer user interface 82 then displays 896 the confirmation number, e.g. #WU11223344 (FIG. 19), in a payment successful message 842 (FIG. 19) through the customer browser 58, for the customer user USR.

The vendor service 16, such as an external vendor service 16, preferably ensures that the payment process is fully processed and recorded, in the event of a system outage or if the network 10 breaks down. In some system embodiments 10,12, an external vendor service 16 provides a subsequent web service that allows the payment system 12 to make an inquiry on a previous requested payment.

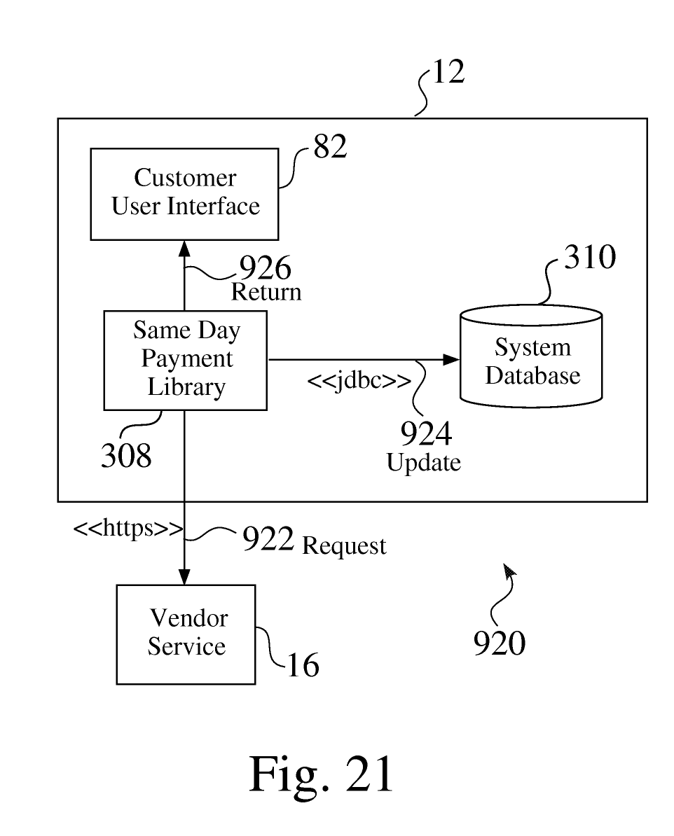

FIG. 21 is an exemplary schematic diagram of reverse payment interactions 920 for an enhanced same day payment system 12 implemented within an online banking system network 10. For example, if the same day payment module 308 experiences an internal debit processing error and needs to back out a previous payment request, the same day payment module 308 may send 922 a reverse payment request to the vendor service 16. The same day payment module 308 also marks the transaction as failed, and updates 924 the information stored at the system database 310. As well, the same day payment module 308 returns 926 the failed transaction back to the main application, e.g. the customer user interface 82.

The vendor service 16 may preferably define a SOAP header for any needed authentication elements and time stamp of the reverse payment message 922. Exemplary Request and Response message contents in the SOAP body are listed as shown:

| | |
|---|---|
| Data Element | Description |

Reverse Payment Request Message.

| | |
|---|---|
| Payment_Id | From the previous payment request. |
| Customer_Name | Customer's full name |
| Customer_Address | Customer's address (street1, 2, city, |
| | state, zip) |
| Customer_Account_Number | Customer's account |
| | number on the merchant (payee) end |
| Biller_Information | Biller Info from external |
| | vendor (name, addr, acct, etc.) |
| Payment_Amount | Payment amount |
| Confirmation_Number | From the previous payment response. |

Reverse Payment Response Message.

| | |
|---|---|
| Payment_Id | From the request message. |
| Confirmation_Number | A generated confirmation number from the |
| | external vendor. |
| Exception | If failed, an exception object is generated |
| | from the vendor. |

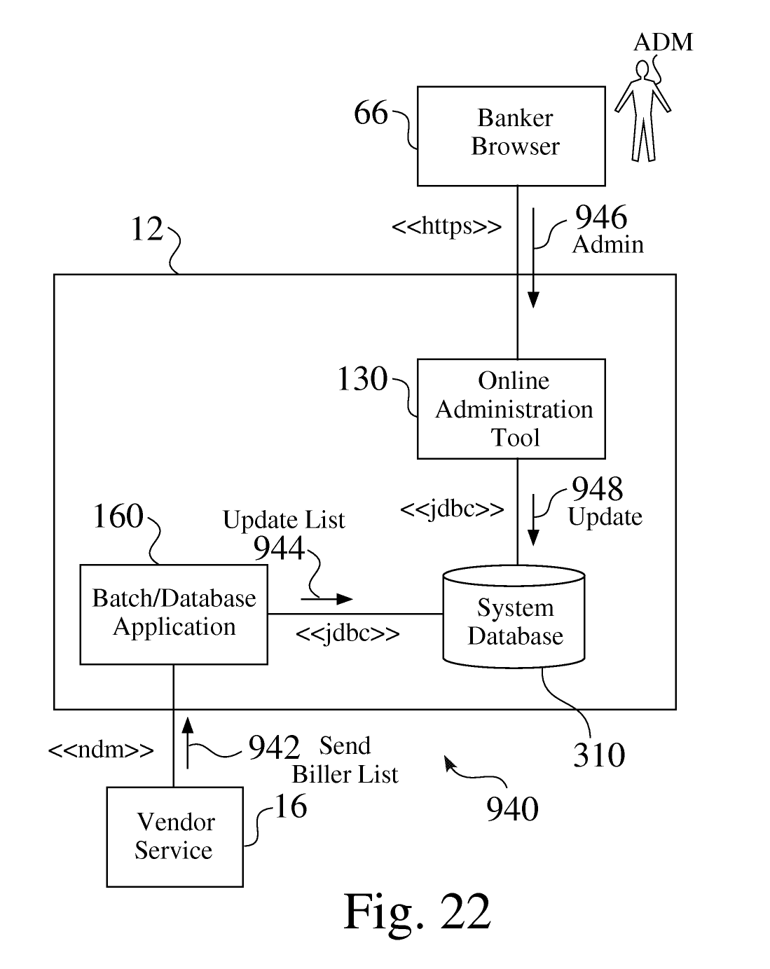

FIG. 22 is an exemplary schematic diagram for the establishment, updating, and/or retrieval 940 of a list of eligible billers 18 for an enhanced online payment system 12 implemented within an online banking system network 10. At a defined frequency, the service vendor 16, e.g. external vendor 16 sends 942 a list of updated eligible billers 18 to the payment system 12, e.g. such as to the batch system 160, through a secured file transfer, e.g. NDM. The batch system 160 then updates 944 the biller information at the payment system database 310, after receiving the updated eligible billers 18 from the vendor service 16. A banker administrator ADM administers 946 the eligible billers list through the online administration tool 130, to make them available for payment system applications, e.g. 82, to display them to customers USR. The online administration tool 130 updates the available eligible billers list at the system database 310, based on the banker's actions.

FIG. 23 is an exemplary schematic diagram of daily settlement interactions 960 for an enhanced online payment system 12 implemented within an online banking system network 10. The vendor service 16, e.g. an external vendor service 16, sends 962 a daily settlement file to the batch system 160, such as through a secured file transfer, e.g. NDM. As well, system backend systems 964 send 966 daily error transactions to the batch system 160. The batch system 160 processes and stores a daily settlement 968 at the system database 310, based on the files received by the vendor service 16 and the back end systems 964. The batch system 160 also writes online settlement reports 970, such as to the online reporting system 306.

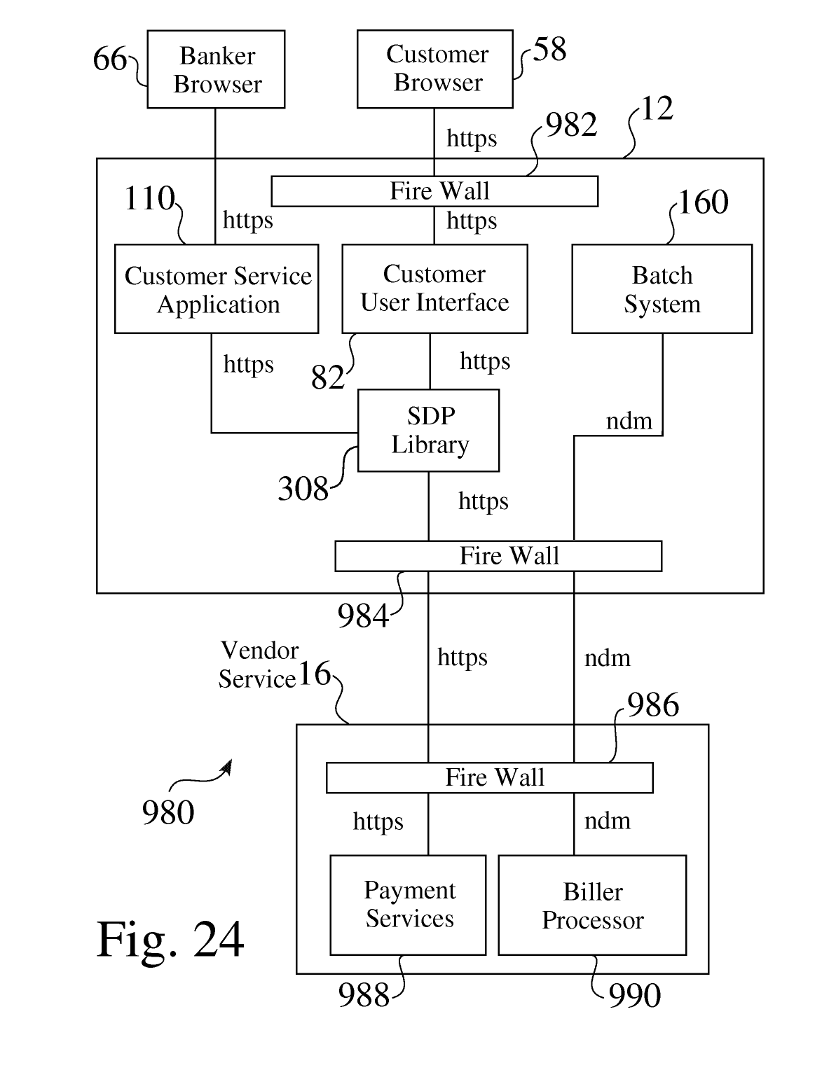

System Interconnections. FIG. 24 is a schematic component and interconnection diagram 980 between system entities for an exemplary same day payment system 12 implemented within an online banking system network 10. As seen in FIG. 24, an exemplary vendor service 16 may typically comprise payment services 988 and a biller processor 990, and may also comprise a firewall 986 for system interconnections. As also seen in FIG. 24, the enhanced payment system 12 may also typically include firewall protection, such as a firewall 984 for communication with one or more vendor services 16, and a client firewall 982, located between the customer user interface 82 and customer browsers 58.

Through the enhanced online payment system 12, a customer USR to schedule payments and make same day payments to one or more payees 18 from the list of payees 18 associated with their account. The enhanced online payment system 12 allows the customer USR to schedule regular and expedited payments, and provides details for payments he/she chooses to make.

The enhanced online payment system 12 provides a same day payment option for payees who are eligible for same day payments, processes the same day payment request, and provides real time confirmation to the customer USR.

For example, in a typical same day payment process, a customer USR may request to make payment(s) to one or more payees 18 from the list of payees 18 associated with their account 742. The system 12 provides the list of payees 18, such as seen in FIG. 16. The system 12 then provides the customer USR the with following options:
for each payee, the system 12 allows the customer USR to enter or select payment amount and send on date; and
displays the expedited option, e.g. in a Send On Date column within the user interface 82, if the payee 18 is eligible for same day payments.

The customer USR can then controllably provide the payment amount 744 and/or send on date for each payee that he/she wants to make a payment, and requests to proceed.

The system 12 then displays detailed payment item details for each payee 18, such as within a CUI Make Payment screen 780 (FIG. 18). For same day payment eligible payees 18, the system 12 provides additional details for each payment item, such as comprising any of:
a message stating that a same day payment option is available;
a delivery time section with radio buttons for standard delivery and same day options. The default is the standard delivery option;
a fee associated with each Payee;
cut-off day and time message associated with each Payee; and
in embodiments that require a funding demand deposit account (DDA) 742, if funding account is not a demand deposit account (DDA), the system 12 does not allow same day payment option (e.g. such as by graying out same day radio button and caption).

The system 12 typically requests the customer USR to provide information for each payment, such as comprising:
funding account 742 from the list of eligible funding accounts for this Bill Pay Customer. The default is the funding account designated for each Payee (currently required);
Payment amount, which may be populated with value entered on CUI Bill Pay Overview screen 740 (FIG. 17);
Send on date, which may be populated with values on CUI Bill Pay Overview screen 740, e.g. this is typically required for scheduled payments, and uses today's date for same day payment. The current system embodiment 12 does not allow the customer USR to change a send on date if same day option is chosen, e.g. by graying out the associated send on date and calendar;
Payment category from the list of payment categories. The default is the payment category associated for each Payee. (currently required);
any memo associated with the payment (Optional); and/or
delivery time, e.g. standard delivery or same day (currently required, wherein default is currently standard delivery).

The customer USR then interacts with the system 12, to provide the required information and selects same day payment option for one or more payment(s). The customer then typically submits the payment requests.

In response, the system 12 validates the information that the customer USR submitted. For same day payment(s), the system 12, in addition to the existing validations, also validates the check for available funds in funding account 742, e.g. the demand deposit DDA funding account, and checks available funds in all overdraft accounts if necessary.

The system 12 then typically requests verification of requested same day payments 744, and requests that the customer USR confirm their request for same day payment(s). The verification request typically includes a communication or display to the user USR, such as through a payment verification screen 780 of the customer user interface 82. For example, a payment verification screen 780 may typically display payee name, funding account 742, payment amount 742, send on date, payment category, payment option, memo, cutoff day/time message and fee associated with each same day payment; and the total payment amount and total amounts to be charged for the same day payment requests.

When the customer confirms the verification request, such as by hitting the submit button 785 (FIG. 18), the system currently processes the same day payment requests in real time, and performs the following actions for each same day payment:
send the request to post payment to the external vendor 16, e.g. Western Union;
send an alert for a successful external vendor request; and
sends request to deduct the amount 744 and same day payment fee 750 from the customer's demand deposit account (DDA) account 742.

For an enhanced payment system 12 that also provides non-expedited, i.e. standard scheduled payment requests, the system also processes the scheduled payment requests for each scheduled payment.

The system 12 then provides a confirmation message to the customer user USR, and typically and provides the following information about the payment(s):
Pending Payments: For each funding account, list of pending payments—payee name, payment amount, reference # (generated by the system), date on which the payment to be sent, and the total number of scheduled payment(s) and the amount total for the scheduled payment(s);
Processed Payments: For each funding account, list of processed payments—payee name, payment amount, reference # (WU confirmation number), date on which the payment to be sent, payment fee, and the total number of same day payment(s) and the amount total for same day payment(s);
Rejected Payments: For each funding account, list of rejected payments—payee name, payment amount, date on which the payment to be sent, error message and the total number of rejected same day payment(s) and the amount total for rejected same day payment(s); and
Total number of payments and the amount total for all payment(s).

Current embodiments of the expedited payment system 12 therefore provide memo debiting and confirmation of the customer's funding accounts 742 in real time or near-real time, wherein the transaction funds are reserved, i.e. frozen, at time of customer submittal, for payments to billers 18 that have established payment relationships, e.g. cut-off times, accepting payment confirmation in real-time and actual payments in batch, etc., through the vendor service 18. In current embodiments of the expedited payment system 12, the actual transfer of funds from the funding accounts 742 happens in batch mode, e.g. end of day, e.g. 10 PM, such as to settlement account 330 and a fee account 332. The actual payment of funds from the payment system 12 to the vendor service 16, and from the vendor service 16 to the billers 18, is also typically performed in batch mode. In current system embodiments 12, therefore, the payment system 12 receives funds in batch before sending payment funds in batch to the vendor service(s) 16, and the vendor service(s) 16 receive funds in batch before sending payment funds to the billers 18.

The enhanced online banking and payment system 12 provides customers USR with the ability to make a “last minute” or same day payment, such as for a mortgage, credit card or utility payment for an additional fee. Customers receive a tremendous benefit from this type of service by being able to avoid late charges, penalties, disconnections and negative remarks on credit reports. In addition, they receive peace of mind by obtaining a confirmation that their payment has been received, and do not have to worry about their credit obligation. The enhanced payment system 12 is preferably available at all times, e.g. 24 hours a day, 7 day a week, wherein a user USR can access the system and initiate an expedited payment.

The enhanced online banking and payment system 12 provides two communication channels for both real-time messaging and secured file transfer, e.g. HTTPS, between the system 12 and the external vendor service 16. The first real-time messaging service connection is used in conjunction with requests for same day payments and the second communication channel is used for reversing one or more previous requests.

The enhanced online banking and payment system 12 currently receives two secured file transfers from the external vendor service, comprising a first file transfer for a periodic eligible billers update, and a second file transfer comprising a daily settlement from the external vendor 16.

While the expedited payment system and its methods of use are described herein in connection with client machines operating across a network, such as computers, servers, wireless devices, personal computers and other microprocessor-based devices, such as wireless appliances, the structure and techniques can be implemented for a wide variety of electronic devices and systems, or any combination thereof, as desired.

Furthermore, while the expedited payment system and its methods of use are described herein in connection with computing devices and payment networks, the apparatus and techniques can be implemented for a wide variety of electronic devices and networks or any combination thereof, as desired.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A process for expedited payment between a first computer and a biller computer implemented across a network, the first computer comprising any of a customer computer associated with a customer and a bank computer, the process comprising the steps of:
receiving at a payment system associated first entity a request sent from the first computer for an expedited payment to a selected biller from a funding account associated with the customer;
verifying through the payment system that the funding account has sufficient funds available for the requested transaction;
sending a payment instruction message from the payment system to a vendor computer associated with a vendor service, if the funding account has sufficient funds available for the requested transaction;
sending payment data from the vendor computer to the biller computer;
sending a payment message from the vendor computer to the payment system; and
debiting the funding account for the transaction.

2. The process of claim 1, wherein the expedited payment further comprises a transaction fee to be charged to an account associated with the customer.

3. The process of claim 2, wherein the verification step determines if the funding account has sufficient funds available for both the expedited payment and for the transaction fee, and where both the expedited payment and the transaction fee are debited from the funding account.

4. The process of claim 1, wherein the biller is selected from a list of eligible billers.

5. The process of claim 4, wherein the list of eligible billers is supplied to the payment system from a computer associated with the vendor service.

6. The process of claim 1, further comprising the step of:
sending payment status information from the payment system to the first computer, in response to information sent to the payment system from the vendor computer.

7. The process of claim 6, wherein the payment status information comprises any of a confirmation of a successful payment and an indication of an unsuccessful payment.

8. The process of claim 1, further comprising the step of:
crediting an account associated with the selected biller.

9. The process of claim 1, wherein the payment message comprises a confirmation number.

10. The process of claim 1, wherein the expedited payment is completed on the same day as the payment request.

11. The process of claim 1, wherein at least one of the process steps is performed in any of real time and near-real time.

12. The process of claim 1, wherein the biller has an associated cut-off time, and wherein the expedited payment is completed on the same day as the payment request if the payment request is received before the cut-off time associated with the biller.

13. The process of claim 1, wherein the funding account comprises a demand deposit account (DDA).

14. The process of claim 1, wherein the payment system overdrafts the funding account if necessary.

15. The process of claim 1, wherein the funding account is charged one overdraft as necessary for the expedited transaction and an associated expedited transaction fee.

16. A system for expedited payment between a first computer and a biller computer implemented across a network, the first computer comprising any of a customer computer associated with a customer and a bank computer, the system comprising:
means for receiving at a payment system computer associated with a first entity a request sent from the first computer for an expedited payment to a selected biller from a funding account associated with the customer;
means for verifying that the funding account has sufficient funds available for the requested transaction;
means for sending a payment instruction message from the payment system computer to a vendor computer associated with a vendor service, if the funding account has sufficient funds available for the requested transaction;
means for sending payment data from the vendor computer to the biller computer;
means for sending a payment message from the vendor computer to the payment system computer; and
means for debiting the funding account for the transaction.

17. The system of claim 16, wherein the expedited payment further comprises a transaction fee to be charged to an account associated with the customer.

18. The system of claim 17, wherein the verification means comprises means for determining if the funding account has sufficient funds available for both the expedited payment and for the transaction fee, and where both the expedited payment and the transaction fee are to be debited from the funding account.

19. The system of claim 16, wherein the biller is selectable from a list of eligible billers.

20. The system of claim 19, wherein the list of eligible billers is supplied to the payment system from a computer associated with the vendor service.

21. The system of claim 16, further comprising:
means for sending payment status information from the payment system to the first computer, in response to information sent to the payment system from the vendor computer.

22. The system of claim 21, wherein the payment status information comprises any of a confirmation of a successful payment and an indication of an unsuccessful payment.

23. The system of claim 16, further comprising:
means for crediting an account associated with the selected biller.

24. The system of claim 16, wherein the payment message comprises a confirmation number.

25. The system of claim 16, wherein the expedited payment is completed on the same day as the payment request.

26. The system of claim 16, wherein the biller has an associated cut-off time, the system further comprising:
means for completing the expedited payment on the same day as the payment request if the payment request is received before the cut-off time associated with the biller.

27. The system of claim 16, wherein the funding account comprises a demand deposit account (DDA).

28. The system of claim 16, further comprising:
means for overdrafting the funding account if necessary.

29. The system of claim 16, further comprising:
means for charging funding account is charged one overdraft as necessary for the expedited transaction and an associated expedited transaction fee.

30. The system of claim 16, wherein the biller computer is located in the United States.
